(19) United States
(12) Patent Application Publication
(10) Pub. No.: US 2016/0003716 A1
(43) Pub. Date: Jan. 7, 2016

(54) Novel Methods of Tissue Processing and Imaging

(71) Applicants: Richard Torres, East Haven, CT (US); Michael Levene, Danbury, CT (US)

(72) Inventors: Richard Torres, East Haven, CT (US); Michael Levene, Danbury, CT (US)

(21) Appl. No.: 14/790,917

(22) Filed: Jul. 2, 2015

Related U.S. Application Data
(63) Continuation-in-part of application No. 14/324,019, filed on Jul. 3, 2014.

(51) Int. Cl. G01N 1/30; G01N 21/64

(52) U.S. Cl. CPC G01N 1/30; G01N 21/6428; G01N 21/6458; G01N 2001/302; G01N 2021/6439

(57) ABSTRACT

The present invention includes novel methods of processing a tissue sample. The present invention also includes novel methods of imaging a tissue sample. The present invention further includes a specimen holding device for performing the novel methods of processing a tissue sample and a microscope system for performing the novel methods of imaging a tissue sample.

### STATEMENT REGARDING FEDERALLY SPONSORED RESEARCH OR DEVELOPMENT

This invention was made with government support under grant No. DBI-0953902 awarded by the National Science Foundation. The government has certain rights in the invention.

### CROSS REFERENCE TO RELATED APPLICATIONS

The present application is entitled to priority to U.S. patent application Ser. No. 14/324,019, filed Jul. 3, 2014, which application is hereby incorporated by reference herein in its entirety.

### BACKGROUND OF THE INVENTION

Automated histology laboratory instrumentation has significantly improved the ability of pathology laboratories to process tissue samples, particularly biopsy samples, in a relatively rapid and consistent manner. These efforts have also reduced somewhat the dependence on skilled histology personnel and improved the quality of diagnostic material. Similarly, with all its limitations, the current evolution of slide-scanning technology has begun to make remote viewing and digital storage of tissue samples a reality. But there are aspects of traditional paraffin-embedded, microtome-cut, hematoxylin-eosin (H&E)-stained slices for routine pathologic evaluation that limit the ability to make more significant advances in the speed, quality, and completeness of tissue biopsy evaluation.

Visual examination of tissue samples remains a mainstay of diagnostic analysis of tissue but there is an increasing role of ancillary studies such as that derived from genetic and proteomic data. This trend is dependent on the availability of sufficient and adequately preserved tissue which competes with the interest for smaller samples and faster results. In addition, incomplete sample evaluation, artifacts of preparation, non-quantitative interpretation, limited growth pattern information, and an extended manual preparative process are some of the aspects of traditional slide-based histologic analysis of human samples that limit advancements in pathology. These are particularly relevant for the usual initial diagnostic step in pathologic assessment which is often core biopsies or fine needle aspirations.

Many alternative tissue processing and imaging approaches have been proposed to address limitations of traditional processing techniques. More recent ones include high-resolution x-ray computed tomography (Zehbe et al., 2010, J. R. Soc. Interface 7:49-59; Ritman, 2011, Annu Rev. Biomed. Eng. 13:531-552) and optical coherence tomography (Zysk et al., 2007, J. Biomed. Opt. 12:051403-051403-21; Bizheva et al., 2005, J. Biomed. Opt. 10:11006-11006-07). These approaches have the advantages of being applicable to unprocessed fresh tissue and allowing complete 3-dimensional visual examination while leaving tissue unaltered and amenable to further characterization. At the present time, neither technique is able to produce images of sufficient resolution and contrast for adequate routine pathology evaluation.

Multiphoton microscopy (MPM), on the other hand, has the ability to provide images with excellent cellular detail and is a popular, powerful method for analysis of research samples. Use of short-pulse laser light also permits concurrent mapping of second-harmonic generation (SHG), making it possible to simultaneously produce quantifiable images of repeating asymmetric protein structures such as collagen and amyloid. Unfortunately, although the long wavelengths used in MPM can image deeper into tissue than confocal microscopy, traditional methods can only achieve clear images at depths of at most 50 μm with formalin-fixed specimens. Previous attempts to use MPM for imaging through fixed tissue have used serial sectioning (Ragan et al., 2007, J. Biomed. Opt. 12:014015-014015-9) or serial tissue ablation (Dechet et al., 1999, J. Urol. 162:1282-1284), which are either very labor intensive or result in the destruction of the tissue specimen during the course of imaging, making them nonviable for routine clinical use.

A significant proportion of surgeries involve intraoperative microscopic consultation. The consultation is mainly for determining the need for additional resection or modification of procedure based on either the characterization of tumor type or the presence of malignancy at a margin. The risk of errors is highly consequential—e.g. repeat surgery, permanent physical harm from unnecessary procedures, and even death. However, there are many well-known limitations to current standard methods of intraoperative microscopy, typically done with frozen sections. Chief among these are resistance to freezing of certain tissue types and morphology distortions associated with the flash freezing process that result in very poor image quality, in many cases precluding their use altogether.

The above noted points indicate that novel methods of tissue processing for imaging of uncut and un-embedded samples are desirable. Tissue clearing presents a useful approach to practically and significantly increase the accessible depth of imaging for various modes of optical sectioning microscopy. Past efforts to obtain high resolution images at depth with clearing have been limited to a small set of applications. These past approaches have failed to develop a processing method that can achieve the speed necessary for adequate implementation in routine pathology and many types of investigative work. They have also not been able to faithfully reproduce the types of coloration that trained specialists in morphologic evaluation are accustomed to interpreting.

Thus, there remains a need for a practical new processing method that can obtain high resolution images of tissue at depth in a relatively short period of time. Additionally, there is a need for these depth images to be obtained in a manner that makes them instantly recognizable by pathologists and microanatomy investigators. The present invention addresses this unmet need.

### BRIEF SUMMARY OF THE INVENTION

A method of processing a tissue sample is described. The method includes the steps of obtaining a tissue sample, and contacting the tissue sample with a fixative solution comprising at least one fixative and at least one fluorescent dye. In one embodiment, the method further includes the step of contacting the tissue sample with a clearing solution. In another embodiment, the method further includes the step of imaging the tissue sample to produce a visual image of the tissue sample. In another embodiment, the at least one fluorescent dye is selected from the group consisting of eosin, DAPI, SYTOX green, acridine orange, rhodamine B, propidium iodide, and a Hoechst dye. In another embodiment, the at least one fixative is methacarn. In another embodiment, the fixative solution further comprises a permeation enhancer. In another embodiment, the step of contacting the tissue sample with a fixative solution is performed at about 45° C. In another embodiment, the fixative solution further comprises a red blood cell lysing agent. In another embodiment, the step of contacting the tissue sample with a fixative solution is performed over a period of time of about 1 hour. In another embodiment, the step of contacting the tissue sample with a fixative solution is performed over a period of less than 15 minutes. In another embodiment, the clearing solution comprises benzyl alcohol and benzyl benzoate. In another embodiment, the ratio of benzyl alcohol to benzyl benzoate is about 1:2. In another embodiment, the step of contacting the tissue sample with a clearing solution is performed over a period of time of about 10 minutes. In another embodiment, a partially fixed and a partially cleared tissue is placed in fixative after imaging. In another embodiment, the steps of contacting the tissue sample with a fixative solution and contacting the tissue sample with a clearing solution are performed over a period of time of about 1.5 hours. In another embodiment, the tissue sample has been fixed prior to obtaining the tissue sample.

Also described is a method of imaging a tissue sample. The method includes the steps of obtaining a tissue sample, contacting the tissue sample with a fixative solution comprising at least one fluorescent dye, contacting the tissue sample with a clearing solution, and producing a tissue sample image by measuring intensity values of the fluorescence of the tissue sample, and converting the intensity values to effective optical densities, such that the optical densities recreate the coloration of a stain in a produced image of the tissue sample. In one embodiment, the tissue sample image is produced using an optical sectioning microscope. In various embodiments, the optical sectioning microscope is selected from the group consisting of: a multiphoton microscope (MPM), a confocal microscope, a structured illumination microscope, a super-resolution microscope, a selective plane illumination microscope (SPIM), a side-plane illumination microscope, a spinning disk confocal microscope, and a deconvolution microscope. In another embodiment, the step of producing a tissue sample image further comprises second harmonic generation (SHG). In another embodiment, the sample image is a three dimensional (3-D) sample image. In another embodiment, the sample image is obtained at a sample depth of greater than 50 μm. In another embodiment, the intensity values are converted to effective optical densities using an exponential pseudo-coloration process.

The invention also relates to a specimen holding device. The specimen holding device comprises a first plate comprising a compressible material and a second plate comprising a window, wherein the window comprises a transparent material. In one embodiment, the compressible material has the form of a closed perimeter. In another embodiment, the compressible material has the form of a solid block. In one embodiment, the first plate and the second plate are dimensioned to fit on a microscope stage. In one embodiment, the first plate and the second plate engage to each other via a tab and reciprocal slot. In one embodiment, the compressible material is porous. In various embodiments, the compressible material is selected from the group consisting of: sponges, foams, meshes, rubbers, polymers, and corks.

The invention also relates to a system for imaging a specimen. The system comprises the specimen holding device of the present invention and a microscope. The microscope comprises a laser source, a scanning mechanism, a scan lens, a tube lens, a microscope objective, and a translation stage, wherein the microscope translation stage is suitable for presenting the specimen held by the specimen holding device of the present invention under the microscope objective. In one embodiment, the microscope further comprises a beam shaper. In one embodiment, the microscope further comprises at least one dichroic mirror for reflecting fluorescent light. In one embodiment, the microscope further comprises at least one detector for detecting transmitted light signals. In one embodiment, the microscope further comprises at least one emission filter. In various embodiments, the microscope laser source is selected from the group consisting of a femtosecond laser, a picosecond laser, a pulsed fiber laser, and a non-tunable laser. In one embodiment, the microscope laser has a center wavelength of 800 nm. In various embodiments, the microscope scanning mechanism is selected from the group consisting of a resonant galvanometer and a spinning polygon having mirrored facets. In one embodiment, the microscope objective has a numerical aperture of at least 0.8. In one embodiment, the microscope objective has a field of view of at least 500 μm.

The invention also relates to a kit for processing a tissue sample. The kit comprises at least one fixative solution comprising at least one fixative, at least one fluorescent dye, and instructional material for performing the method of the present invention. In one embodiment, the at least one fixative solution is methacarn. In one embodiment, the at least one fluorescent dye is selected from the group consisting of eosin, DAPI, SYTOX green, acridine orange, rhodamine B, propidium iodide, and a Hoechst dye. In one embodiment, the kit further comprises at least one clearing solution. In one embodiment, the at least one clearing solution comprises benzyl alcohol and benzyl benzoate. In one embodiment, the kit further comprises a specimen holding device having a first plate comprising a compressible material and a second plate comprising a window, wherein the window comprises a transparent material. In one embodiment, the kit further comprises the system of the invention as described elsewhere herein.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

The patent or application file contains at least one drawing executed in color. Copies of this patent or patent application publication with color drawing(s) will be provided by the Office upon request and payment of the necessary fee.

FIG. 1 depicts a flow chart illustrating an exemplary method for processing and imaging a sample.

FIG. 2, comprising FIGS. 2A-2D, depicts images of examples of clearing. Formalin-fixed tissue sections of breast (FIG. 2A) and liver (FIG. 2B) before and after (FIG. 2C and FIG. 2D, respectively) a benzyl alcohol/benzyl benzoate clearing protocol. Note near-complete transparency of breast tissue specimen and translucency of liver specimen with some remaining pigment. Grid line spacing is 0.9 cm.

FIG. 3, comprising FIGS. 3A-3D, depicts multiphoton microscopy images of clarified normal human tissue. Specimens were stained either with SYTOX Green or acridine orange nucleic acid dyes during dehydration steps. FIG. 3A is an image of a prostate tissue sample acquired at medium power. FIG. 3B is an image of a liver tissue sample acquired at high power. FIG. 3C is an image of a breast tissue sample acquired at medium power. FIG. 3D is an image of a kidney tissue sample acquired at medium power. Images are from depths ranging from 200 to 500 μm. Morphologic detail was comparable at 1 mm in depth.

FIG. 4, comprising FIGS. 4A-4C, depicts multichannel data for a kidney section. FIG. 4A is an image of intrinsic fluorescence dominated by signal from cell cytoplasm. FIG. 4B is an image of inverted nucleic acid fluorescence channel highlighting predominantly nuclear DNA and some cytoplasmic RNA. FIG. 4C is an image of combined intrinsic fluorescence and nuclear fluorescence (gray scale) with second-harmonic generation channel in red showing distribution of collagen fibers around a normal glomerulus.

FIG. 5 is an image demonstrating pseudo-colorization. Prostate section obtained with multiphoton microscopy on cleared tissue with SYTOX Green at depth of approximately 500 μm (as in FIG. 4), processed to mimic hematoxylin-eosin section.

FIG. 6, comprising FIGS. 6A-6D, depicts hematoxylin-eosin (H&E)-stained images post multiphoton microscopy (MPM) of clarified tissue. Sample sections from the same specimens depicted in FIG. 3, including prostate (FIG. 6A), liver (FIG. 6B), breast (FIG. 6C), and kidney (FIG. 6D), show no perceptible degradation or other visual change with traditional wax embedding, cutting, and H&E staining after clarification of tissue and MPM imaging (original magnifications ×20 [FIGS. 6A, 6C, and 6D] and ×50 [FIG. 6B]).

FIG. 7, comprising FIGS. 7A-7B, depicts images demonstrating examples of compatibility of benzyl alcohol/benzyl benzoate clearing and SYTOX Green staining with traditional immunohistochemistry on human renal tissue. FIG. 7A is an image depicting cytokeratin (CK) 7 stain of normal kidney showing expected pattern of transition to positive staining on descending medullary cords. FIG. 7B is an image depicting appropriate lack of staining of same renal tissue with CK20 (original magnifications ×4 [FIGS. 5A and 5B]).

FIG. 8, comprising FIGS. 8A-8C, depicts representative large block 3-D reconstructions of normal human tissue. FIG. 8A is an image depicting approximately 1-mm cubic section of normal human liver obtained by multiphoton microscopy on cleared tissue without staining (intrinsic fluorescence only, low power). FIG. 8B is an image depicting similar sized block of normal human breast tissue, which has been fixed, cleared, and stained with the nucleic acid dye SYTOX Green (low power). FIG. 8C is a perspective image of 3-D reconstruction of collagen from normal human kidney (approximately 200×200×40 μm).

FIG. 9, comprising FIGS. 9A-9C, depicts various tissue samples. FIG. 9A is an image of an uncleared sample. FIG. 9B is an image of a sample produced with a traditional method of tissue clearing involving increasing gradients of ethanol (50%, 75%, 100%), followed by immersion in hexane, followed by immersion in benzyl alcohol:benzyl benzoate in a 1:2 ratio, executed in a time period of 1.25 hours. FIG. 9C is an image depicting a sample processed using the methods of the present invention over the same period of 1.25 hours. At time 1.25 hours (15 mins clearing post processing), clearing with the method of the present invention shows deeper clearing (smaller core of uncleared volume) compared to traditional processing. The traditional method also shows leeching of fluorescent dye into BABB (red tint to liquid).

FIG. 10 is a graph depicting the normalized average dye staining with depth at 1.5 h. At time 1.5 h, tissue processing using the methods of the present invention exhibits significantly better dye penetration than ethanol/hexane/BABB traditional processing as described for FIG. 9.

FIG. 11, comprising FIGS. 11A-11B, depicts images of tissues processed using traditional processing methods and methods of the present invention. FIG. 11A is a series of images of tissues processed using traditional processing methods. FIG. 11B is a series of images of tissues processed using the methods of the present invention. The methods of the present invention result in better separation of nuclear and protein fluorescence signals with inexpensive dye combinations and exhibit improved detail at 500 μm deep with significantly less cell shrinkage.

FIG. 12 is a series of images depicting images of tissue samples processed using methacarn or methanol, and treated with heat or without heat.

FIG. 13 is a graph depicting normalized staining intensity versus depth for samples processed with methacarn, methanol only, and no heat.

FIG. 14, comprising FIGS. 14A-14C, depicts images of tissues processed using pseudo-H&E. FIG. 14A is an image of tissue processed with nuclear stain. FIG. 14B is an image of tissue processed with protein fluorescence. FIG. 14C is an image of tissue imaged with an inversion of logarithmic matrix conversion using images depicted in FIGS. 14A and 14B.

FIG. 15 depicts a series of images of tissue samples prepared using methods of the present invention.

FIG. 16 is a diagram depicting an exemplary specimen holding device of the present invention.

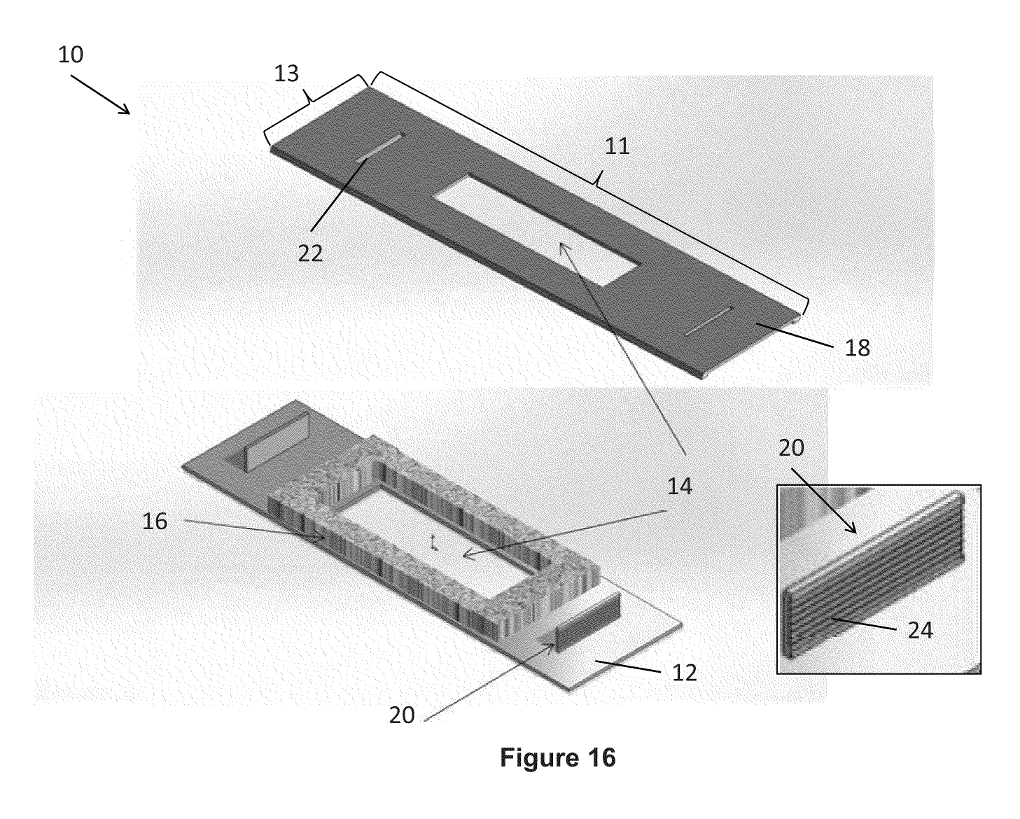

FIG. 17 is a schematic depicting the optical layout of an exemplary microscope system of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in the art related to histology, tissue processing, and the like. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Although any methods, materials and components similar or equivalent to those described herein can be used in the practice or testing of the present invention, the preferred methods and materials are described.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” and “approximately” as used herein when referring to a measurable value such as an amount, a temporal duration, and the like, are meant to encompass variations of ±20% or ±10%, more preferably ±5%, even more preferably ±1%, and still more preferably ±0.1% from the specified value, as such variations are appropriate to perform the disclosed methods.

The term “abnormal” when used in the context of organisms, tissues, cells or components thereof, refers to those organisms, tissues, cells or components thereof that differ in at least one observable or detectable characteristic (e.g., age, treatment, time of day, etc.) from those organisms, tissues, cells or components thereof that display the “normal” (expected) respective characteristic. Characteristics which are normal or expected for one cell or tissue type, might be abnormal for a different cell or tissue type.

A “disease” is a state of health of an animal wherein the animal cannot maintain homeostasis, and wherein if the disease is not ameliorated then the animal's health continues to deteriorate.

In contrast, a “disorder” in an animal is a state of health in which the animal is able to maintain homeostasis, but in which the animal's state of health is less favorable than it would be in the absence of the disorder. Left untreated, a disorder does not necessarily cause a further decrease in the animal's state of health.

The terms “patient,” “subject,” “individual,” and the like are used interchangeably herein, and refer to any animal, or cells thereof whether in vitro or in situ, amenable to the methods described herein. In certain non-limiting embodiments, the patient, subject or individual is a human.

As used herein, the term “fixation” refers any process which halts cellular degradation such as by arresting enzymatic function through protein crosslinking or dehydration.

As used herein, the term “dehydration” refers to removal of water from the sample to aid in preparation for imaging by such effects as arresting enzymatic function and/or creating a solvent environment that is at least partially miscible with a hydrophobic fluid.

As used herein, the term “BABB” refers to a solution of benzyl alcohol and benzyl benzoate. For example, BABB may refer to a solution of benzyl alcohol and benzyl benzoate, wherein the ratio of benzyl alcohol to benzyl benzoate is about 1:2.

As used herein, the term “tissue” means any structure derived from an organism. The term also encompasses any structure excised or removed from an organism. As used herein, an organism from which “tissue” is derived need not be exclusively a human being, but rather the term encompasses tissue derived from any organism. With respect to humans, the term includes a structure derived from either a living human or a cadaver. In certain embodiments, tissue is derived from a mammal, including, but not limited to, humans, rats, mice and sheep.

As used herein, the term “deep imaging” refers to imaging at a distance from a surface that is larger than what is typically accessible for the level of contrast and resolution associated with traditionally-cut thin slices of tissue. This accessible depth varies with tissue type and the presence and type of fixation. For practical purposes and in this context, deep refers to depths greater than approximately 50 μm.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### DESCRIPTION

The present invention relates to methods of tissue preparation and image-analysis that allow for the practical implementation of the deep imaging of tissue specimens. The methods described herein reduce the number of steps for tissue processing, decrease the time required to process tissues, and improve the clarity and contrast in samples, thereby permitting deep tissue imaging of the sample. As demonstrated herein, the methods of the present invention provide complete visualization of biopsy-sized specimens without the need for the time-consuming and manually intensive post-clearing steps, thereby reducing the time between biopsy through morphologic assessment. In non-limiting examples, cleared biopsy specimens can be provided to pathologists for direct visualization or scanned for image distribution. In another non-limiting example, a primary diagnosis may be rendered based on the images, with subsequent studies ordered if necessary. In another non-limiting example, specimens can be partially fixed and partially cleared for intra-operative evaluation or for any other clinical scenario where a fast visual examination is desired. In further examples, partially fixed specimens may be fully fixed at a later time and partially cleared specimens may be fully cleared at a later time.

In part, the present invention provides a method for image analysis that allows reproduction of images essentially indistinguishable from traditional histology stains. This method provides images of samples that mimic common pathology stains, resulting in the accurate and efficient interpretation of the images. Contrary to currently used color separation algorithms, the methods described herein invert these color separation techniques using the fluorescence of the sample, whether inherent or resulting from a fluorescent dye, to faithfully recreate images comprising the expected colorization of tissues resulting from common stains such as hematoxylin/eosin and wright/giemsa, allowing the images to be easily interpreted by pathologists. Contrary to past efforts of pseudo-colorization, the methods described herein use exponential conversion equations, more closely matching the optical qualities of fluorescence emission to those of light absorption with traditional illumination of thin sections. As demonstrated herein, the methods of the present invention result in the production of images that have resolution and fields of view similar to those produced using current histological methods, provide a contrast similar to that obtained with commonly used histologic stains, and permit subsequent traditional processing without apparent adverse effects. The multichannel method described herein provides straightforward pseudocolorization that represents morphology in an analogous method to traditional stains, allowing pathologists to easily recognize salient histologic features.

With biopsies, there is often a trade-off between keeping sufficient tissue for additional stains or molecular analysis and adequate hematoxylin and eosin (H&E) histology. The necessarily sparse sampling of traditional physical wax-embedding and cutting histology techniques can miss important features. For example, colonic polyps may be missed, small foci of prostate cancer may be non-diagnostic, and focal renal lesions may be unapparent. This problem is compounded by the need to discard initial block shavings for complete sections, particular in imperfectly embedded specimens. The methods described herein obviate these issues that occur when using current histological methods while permitting image reconstruction of entire or deep portions of biopsy specimens.

In the case of rapid analysis, the many artifacts and difficulties associated with tissue freezing and sectioning can be overcome by visualizing un-frozen, uncut tissue with the process presented. In contrast to other related efforts to visualize un-frozen, un-cut fresh tissue with optical sectioning microscopes, the process described here fully addresses challenges that stem from poor refractive index matching and slow dye penetration that preclude imaging of adequate resolution and depth for practical diagnosis with any other known technique.

### Methods

In one aspect, the present invention provides methods of processing and imaging a histological sample. In one embodiment, the method comprises the step of obtaining a sample. The sample can generally be any type of sample. For example, the sample can be a cell or group of cells, an organism, a tissue, cell lysates, a cell culture medium, a bioreactor sample, and so on. In a preferred example, the sample is a tissue sample. In another embodiment, the sample is a fluid sample in which the cellular component has been concentrated such as by centrifugation or filtering. Non-limiting examples of tissues include skin, muscle, bowel, breast, heart, kidney, lung, liver, skin, placenta, prostate, pancreas, uterus, bone, bone marrow, brain, stomach, muscle, cartilage, lymph node, adipose tissue, tonsil, gall bladder, and spleen, as well as the cellular component of cerebrospinal fluid, pleural fluid, ascites fluid, or synovial fluid. In one embodiment, the tissue is liver tissue. In another embodiment, the tissue is kidney tissue. In another embodiment, the tissue is breast tissue. In another embodiment, the tissue is prostate tissue. The sample may be obtained through any method known in the art, as would be understood by one skilled in the art. In some embodiments, the sample is obtained during surgery, biopsy, fine needle aspiration, culture, or autopsy. In one embodiment, the sample is a fresh sample. In another embodiment, the sample is a fixed sample. In one embodiment, the tissue sample is fixed prior to obtaining the tissue sample.

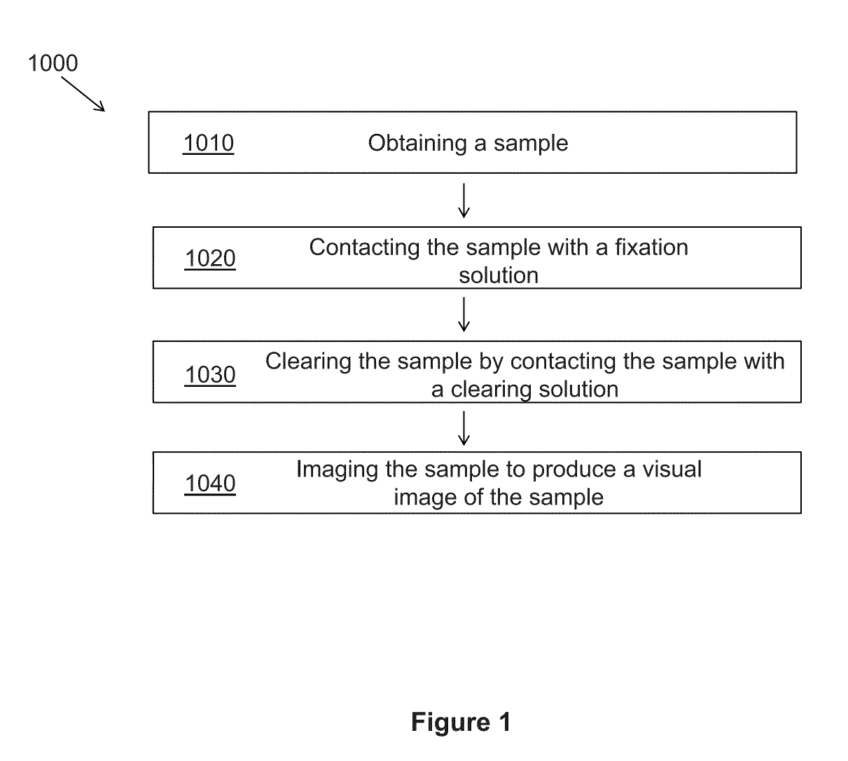

FIG. 1 depicts a flow chart illustrating an exemplary method 1000 for processing and imaging a sample. Method 1000 comprises obtaining a sample 1010, and contacting the sample 1020 with a fixation solution. In a preferred embodiment, the sample is a tissue sample. In certain embodiments, the fixation solution comprises at least one dehydrant and at least one fluorescent dye. In one embodiment, method 1000 comprises clearing the sample 1030 by contacting the sample with a clearing solution to provide increased depth and clarity for imaging the sample 1040. In one embodiment, the sample is fixed prior to being contacted with a solution comprising a fixative or dehydrant and at least one fluorescent dye. In another embodiment the fresh tissue is placed directly in a combination fixation/dehydration fluid with dye or dyes. In some embodiments, the step of imaging the sample is performed in combination with an additional imaging method, such as second harmonic generation (SHG). (FIG. 1). In one embodiment, specimens can be partially fixed for intra-operative evaluation or for any other clinical scenario where a fast visual examination is desired. Partially fixed specimens may be fully fixed at a later time. In another embodiment, specimens can be partially cleared for intra-operative evaluation or for any other clinical scenario where a fast visual examination is desired. Partially cleared specimens may be fully cleared at a later time.

In one aspect, the method of the present invention further comprises the step of dehydrating the sample. Dehydration facilitates the removal of water from a sample so that clearing agents with low water solubility can subsequently be used. It should be appreciated that a dehydrant or a dehydration solution may also be used as a fixative or for fixing a sample. As used herein, the term “dehydrant” refers to a water-miscible anhydrous fluid. Non-limiting examples of dehydrants include alcohols such as methanol, ethanol, and propanol. In one embodiment, the dehydrant is methacarn. In another embodiment, the dehydrant is methanol. In one embodiment, the dehydration step functions as a fixative and takes place without prior fixation of the sample. In other embodiments, the dehydration step is performed after fixation of the sample. In one embodiment, the dehydration step is performed after fixation of the sample using a fixation solution comprising formalin.

The dehydration step can be performed for any suitable length of time. The length of time can generally be any length of time suitable for rendering the sample, or a portion of the sample, miscible with the clearing agent. The length of time can also generally be any length of time suitable for preserving the sample or preserving a portion of the sample. In certain embodiments the period of time may be from about 1 minute, about 5 minutes, about 10 minutes, about 15 minutes, about 30 minutes, about 1 hour, about 2 hours, about 3 hours, about 4 hours, about 5 hours, about 6 hours, about 12 hours, or about 24 hours. In one embodiment, the dehydration step is performed over a period of time about 1 hour. In another embodiment the dehydration step is performed over about 12 to 16 hours.

In one aspect, method of the present invention comprises the step of fixing the sample. The tissue sample may be fixed using any method known in the art, as would be understood by one skilled in the art. In one embodiment, the sample is fixed by contacting the sample with a fixative. In another embodiment, the sample is fixed by contacting the sample with a fixation solution. In one embodiment, the fixation solution comprises at least one fixative. In one embodiment, the fixative is a dehydrant. In another embodiment, the fixation solution is a dehydrant. In another embodiment, the fixation solution comprises at least one fixative and at least one permeant. Non-limiting examples of fixatives include aldehydes (e.g., formaldehyde (paraformaldehyde, formalin), glutaraldehyde, acrolein (acrylic aldehyde), glyoxal (ethanedial, diformyl), malonaldehyde (malonic dialdehyde), diacetyl (2,3-butanedione), and polyaldehydes; alcohols (i.e., protein-denaturing agents; e.g., acetic acid, methanol, ethanol), polyvinyl alcohols, heavy metal oxidizing agents (i.e., metallic ions and complexes; e.g., osmium tetroxide, chromic acid); agents of unknown mechanism, such as chloro-s-triazides, cyanuric chloride, carbodiimides, diisocyanates, diimido esters, diethylpyrocarbonate (diethyl oxydiformate, ethoxyformic anhydrate), picric acid, mercuric chloride (corrosive sublimate, bichloride of mercury), and other salts of mercury, and acetone. In one embodiment, a combination of fixatives is used. Such combinations give rise to commonly termed formulations known to those in the art, such as Carnoy's fixatives, methacarn, Wolman's solution, Rossman's fluid, Gendre's fluid, Bouin's fluid, Zenker's fluid, Helly's fluid, B5 fixative, Susa fluid, Elftman's fixative, Swank and Davenport's fixative, Lillie's alcoholic lead nitrate, and cetylpyridinium chloride (C.P.C.). Additives can include, but are not limited to, such entities as tannic acid, phenol, transition metal salts (zinc), lanthanum, lithium, potassium. In one embodiment, the fixative is methacarn. In another embodiment, the fixative is formalin. In another embodiment, the fixative is an alcohol. In another embodiment, the fixative is methanol. In another embodiment, the fixative is a polyvinyl alcohol. In another embodiment, the fixative is formaldehyde. In another embodiment, fixation of the sample occurs ex vivo.

In some embodiments, at least one fluorescent dye is added to the sample during the fixation step, resulting in simultaneous fixing and staining of the sample. In other embodiments, at least one fluorescent dye is added to the sample during the dehydration step, resulting in simultaneous dehydration and staining of the sample. The incorporation of a fluorescent dye obviates the need for post-processing staining, which is a time-consuming step of traditional sample preparation. The fluorescent dye may be added directly to the sample during the fixation step. For example, the fluorescent dye may be added to the fixation solution. In another embodiment, the fluorescent dye is added to the sample after completion of the fixation step. In one embodiment, the fixation solution comprises a fixative and a fluorescent dye. In another embodiment, the fixative solution comprises at least one dehydrant and at least one fluorescent dye. In one embodiment, the fluorescent dye is added directly to the sample during the dehydration step. In one embodiment, the method of processing a tissue sample comprises the steps of obtaining a tissue sample, and contacting the tissue sample with a fixative solution comprising at least one dehydrant and at least one fluorescent dye.

The skilled artisan will understand that the present invention contemplates the use of any fluorescent dye that is compatible with the fixation step. Examples of fluorescent dyes include, but are not limited to, POPO-1, TOTO-3, TAMRA, BOXTO, BEBO, SYBR DX, SYTOX dyes, SYTO dyes, Alexa dyes, fluorescein, rhodamine, propidium idodide, Hoechst dyes, tetramethylrhodamine, R-phycoerythrin, Cy-3, Cy-5, Cy-7, Texas Red, Phar-Red, allophycocyanin (APC), fluorescein amine, eosin, dansyl, umbelliferone, 5-carboxyfluorescein (FAM), 2′7′-dimethoxy-4′5′-dichloro-6-carboxyfluorescein (JOE), 6 carboxyrhodamine (R6G), N,N,N′,N′-tetramethyl-6-carboxyrhodamine (TAMRA), 6-carboxy-X-rhodamine (ROX), 4-(4′-dimethylaminophenylazo) benzoic acid (DABCYL), 5-(2′-aminoethyl)aminonaphthalene-1-sulfonic acid (EDANS), 8-Anilino-1-naphthalenesulfonic acid ammonium salt (ANS), 4-acetamido-4′-isothiocyanatostilbene-2,2′ disulfonic acid, acridine, acridine isothiocyanate, acridine orange (N,N,N′,N′-tetramethylacridine-3,6-diamine), R-amino-N-(3-vinylsulfonyl)phenylnaphthalimide-3,5, disulfonate (Lucifer Yellow VS), N-(4-anilino-1-naphthyl)maleimide, anthranilamide, Brilliant Yellow, coumarin, 7-amino-4-methylcoumarin, 7-amino-4-trifluoromethylcouluarin (Coumarin 151), cyanosine, 2-(4-amidinophenyl)-1H-indole-6-carboxamidine (DAPI), 5′,5″-dibromopyrogallol-sulfonephthalein (Bromopyrogallol Red), 7-diethylamino-3-(4′-isothiocyanatophenyl)-4-methylcoumarin diethylenetriamine pentaacetate, 4,4′-diisothiocyanatodihydro-stilbene-2,2′-disulfonic acid, 4,4′-diisothiocyanatostilbene-2,2′-disulfonic acid, 4-dimethylaminophenylazophenyl-4′-isothiocyanate (DABITC), eosin isothiocyanate, erythrosin B, erythrosin isothiocyanate, ethidium, 5-(4,6-dichlorotriazin-2-yl)aminofluorescein (DTAF), QFITC (XRITC), fluorescamine, IR144, IR1446, Malachite Green isothiocyanate, 4-methylumbelliferone, ortho cresolphthalein, nitrotyrosine, pararosaniline, Phenol Red, B-phycoerythrin, o-phthaldialdehyde, pyrene, pyrene butyrate, succinimidyl 1-pyrene butyrate, Reactive Red 4 (Cibacron® Brilliant Red 3B-A), lissamine rhodamine B sulfonyl chloride, rhodamine B, rhodamine 123, rhodamine X, sulforhodamine B, sulforhodamine 101, sulfonyl chloride derivative of sulforhodamine 101, tetramethyl rhodamine, thiazole orange, riboflavin, rosolic acid, and terbium chelate derivatives. In one embodiment, the fluorescent dye is eosin. In another embodiment, the fluorescent dye is DAPI. In another embodiment, the fluorescent dye is SYTOX green. In another embodiment, the fluorescent dye is acridine orange. In another embodiment, the fluorescent dye is rhodamine B. In another embodiment, the fluorescent dye is a SYTO dye. In another embodiment, the fluorescent dye is propidium iodide. In another embodiment, the fluorescent dye is a Hoechst dye.

In certain embodiments, the fluorescent dye can selectively stain a particular organelle or component of a cell. In one embodiment, the fluorescent dye is a nuclear dye. Non-limiting examples of nuclear dyes include DAPI, SYTOX dyes, SYTO dyes, propidium iodide, acridine orange, and Hoechst dyes. In one embodiment, the nuclear dye is DAPI. In another embodiment, the fluorescent dye is a protein dye. Examples of protein dyes include, but are not limited to, eosin, Rhodamine B (RhB), and ANS. In another embodiment, intrinsic fluorescence of the cell is used to image the cellular protein. In another embodiment, the fluorescence is generated from a combination of at least one nuclear dye and at least one protein dye. In another embodiment, the fluorescence is generated from a nuclear dye and intrinsic fluorescence. In one embodiment, the at least one protein dye is eosin.

In certain embodiments, a morphology preservative is added to the sample during the fixation step and/or the dehydration step. The morphology preservative enhances maintenance of the nuclear structure of the cells, in that it maintains cell membranes intact for subsequent cytological staining and/or reduces shrinking or swelling during fixation or dehydration. Any morphology preservative that is compatible with the fixation step may be used in the invention, as would be understood by one of ordinary skill in the art. Non-limiting examples of morphology preservatives include acetic acid, trichloroacetic acid, formaldehyde, dioxane, chloroform, and the like. In a preferred embodiment, the morphology preservative is chloroform. The morphology preservative may be added directly to the sample during the fixation step. Alternatively, the morphology preservative may be added to the fixation solution. In one embodiment, the fixation solution comprises about 0% to about 50% of a morphology preservative. In another embodiment, the fixation solution comprises about 5% to about 15% of a morphology preservative. In another embodiment, the fixation solution comprises about 10% of a morphology preservative. In another embodiment, the fixation solution comprises about 20% to about 40% of a morphology preservative. In a preferred embodiment, the fixation solution comprises about 30% of a morphology preservative.

In some embodiments, a permeation enhancer is added to the sample during the fixation step and/or the dehydration step. The permeation enhancer accelerates the access of dye to the deeper portion of the sample, while overall improving the dyeing process. The permeation enhancer also accelerates the penetration of fixative, dehydrant, and/or clearing agent. Non-limiting examples of permeation enhancers include acids such as acetic acid, methacarn comprising acetic acid, sulphoxides such as dimethylsulfoxide (DMSO), azone, pyrrolidones, propylene glycol, fatty acids, essential oils, phospholipids, s-collidine, and surfactants such as Tween. In one embodiment, the fixation solution comprises about 0% to about 75% of a permeation enhancer. In another embodiment, the fixation solution comprises about 0% to about 25% of a permeation enhancer. In another embodiment, the fixation solution comprises about 5% to about 15% of a permeation enhancer. In a preferred embodiment, the fixation solution comprises about 10% of a permeation enhancer.

In some embodiments, the permeation enhancer is at least one acid. In some embodiments, the acid is an organic acid. Non-limiting examples of organic acids include acetic acid, glacial acetic acid, lactic acid, propionic acid, butyric acid, succinic acid, citric acid, 3-hydroxypropionic acid, glycolic acid, or formic acid. In one embodiment, the acid is acetic acid. Acetic acid is useful for enhancing the speed of fixation, which is important for rapid sample processing, while also significantly improving the quality and depth of images from cleared samples using any type of sectioning image modalities. Acetic acid is also useful for lysing red blood cells, which allows for removal of heme pigment, which is a significant deterrent to clarity of the sample by virtue of its broad light absorption characteristics in the typical workable wavelength range of routine fluorescent imaging. In one embodiment, the step of fixing the sample further comprises the addition of a lysing agent to the sample. In a particular embodiment, the step of fixing the sample further comprises the addition of a red blood cell lysing agent to the sample. In another embodiment, the step of dehydrating the sample further comprises the addition of a lysing agent to the sample. In another embodiment, the fixative solution further comprises a red blood cell lysing agent. In a preferred embodiment, the red blood cell lysing agent is acetic acid. In other embodiments, the acid is an inorganic acid. The solution may further comprise at least one organic solvent. Non-limiting examples of organic solvents include methanol, absolute methanol, chloroform, dichloromethane, ethanol, isopropanol, acetone, ethyl acetate, acetonitrile, hexane, hexene, octane, pentane, cyclohexane, iso-octane, xylene (ortho, meta, or para), and 1-hexene. In one embodiment, the organic solvent is absolute methanol. Methanol is useful for tissue processing by arresting enzymatic function and degradation while maximally preserving genetic and proteomic information. In another embodiment, the organic solvent is chloroform. In one embodiment, the solution comprises two organic solvents and an acid. As a non-limiting embodiment, the fixative solution comprises about 60% absolute methanol, about 30% chloroform, and about 10% glacial acetic acid, which is also known as methacarn. When in combination with fluorescent dyes and clearing, methacarn may be useful for deep fluorescent tissue section imaging of human samples for histologic evaluation, and for creating the contrast needed for accurate histologic evaluation.

The fixation step may be performed under any condition that promotes rapid tissue processing, such as conditions that increase the rates of chemical reaction and diffusion, as would be understood by one of ordinary skill in the art. In some embodiments, the fixation step is performed at an elevated temperature. As used herein, the term “elevated temperature” refers to temperatures above those experienced in the earth's atmosphere, preferably above 30° C. In one embodiment, the elevated temperature ranges from about 20° C. to about 75° C. In another embodiment, the elevated temperature ranges from about 35° C. to about 50° C. In another embodiment, the elevated temperature is about 45° C. In a non-limiting example, the fixation, dehydration, and/or staining is performed under microwave irradiation for the purpose of accelerating diffusion, chemical reaction, or temperature.

The fixation step can be performed for any suitable length of time. The length of time can generally be any length of time suitable for preserving the sample. In certain embodiments, the period of time may be from about 1 minute, about 5 minutes, about 10 minutes, about 15 minutes, about 30 minutes, about 1 hour, about 2 hours, about 3 hours, about 4 hours, about 5 hours, about 6 hours, about 12 hours, or about 24 hours. In one embodiment, the fixation step is performed over a period of time about 1 hour. In another embodiment the fixation step is performed over about 12 to 16 hours. In another embodiment the fixation step is performed over the course of weeks to years.

In one embodiment, the method of the present invention comprises the step of simultaneously fixing, dehydrating, and staining the sample by contacting the sample with a dehydration solution comprising at least one dehydrant and at least one fluorescent dye. In another embodiment, the method of the present invention comprises the step of simultaneously dehydrating and staining the sample by contacting the sample with a dehydration solution comprising at least one dehydrant and at least one fluorescent dye.

In another aspect, the method of the present invention further comprises the step of clearing the sample. Clearing the sample provides increased depth and clarity of imaging of the sample. In one embodiment, the clearing step is performed in absence of a fixation step. In some embodiments, the step comprises clearing the sample by contacting the sample with a clearing solution. As a non-limiting embodiment, the sample is cleared by replacing water with a clearing solution that has a higher refractive index than water that more closely resembles that of proteins and organelles, thereby drastically reducing light scattering and enabling imaging depths of millimeters instead of micrometers. In one embodiment, the clearing solution comprises at least one solvent. Any solvent may be used in the clearing solution, as long as the overall refractive index of the clearing solution is higher than the refractive index of water and the solvent does not damage the morphology of cellular components of the sample. In one embodiment, the refractive index of the clearing solution ranges from about 1.4 to about 1.6. In another embodiment, the refractive index of the clearing solution ranges from about 1.33 to about 1.49. In another embodiment, the refractive index of the clearing solution is greater than about 1.4. In another embodiment, the refractive index of the clearing solution is greater than about 1.5. In one embodiment, the clearing solution further comprises an agent that is water soluble and has a high refractive index.

In some embodiments, the solvent is an organic solvent. Non-limiting examples of organic solvents useful as clearing agents include, benzyl alcohol, benzyl benzoate, xylene, limonene, benzene, toluene, chloroform, petroleum ether, carbon bisulfide, carbon tetrachloride, dioxane, glycerol, sugar solutions, dibenzyl ether, clove oil, and cedar oil. In one embodiment, the solvent is benzyl alcohol. In another embodiment, the solvent is benzyl benzoate. In another embodiment, the solvent is xylene. In another embodiment, the solvent is glycerol. In another embodiment, the solvent is a sugar solution. In another embodiment, the solvent is dibenzyl ether. In another embodiment, the solvent is hexane.

In some embodiments, the clearing solution comprises a first solvent and a second solvent. In one embodiment, the ratio of the first solvent to the second solvent ranges from about 100:1 to about 1:100. In another embodiment, the ratio of the first solvent to the second solvent ranges from about 10:1 to about 1:10. In another embodiment, the ratio of the first solvent to the second solvent ranges from about 5:1 to about 1:5. In a preferred embodiment, the ratio of the first solvent to the second solvent is about 1:2. In some embodiments, the solvent is an organic solvent. In a particular embodiment, the clearing solution comprises benzyl alcohol and benzyl benzoate. In one embodiment, the ratio of benzyl alcohol to benzyl benzoate is about 1:2.

The clearing step may be performed under any condition that promotes rapid clearing of the sample, as would be understood by one of ordinary skill in the art. In some embodiments, the clearing step is performed at an elevated temperature. In one embodiment, the elevated temperature ranges from about 20° C. to about 75° C. In another embodiment, the elevated temperature ranges from about 35° C. to about 50° C. In another embodiment, the temperature is about 22° C.

The clearing step can be performed for any suitable length of time. The length of time can generally be any length of time suitable for achieving sufficient reduction in light scattering to enable imaging to the desired depth in the sample. In certain embodiments, the period of time may be from about 1 minute, about 5 minutes, about 10 minutes, about 15 minutes, about 30 minutes, about 1 hour, about 2 hours, about 3 hours, about 4 hours, about 5 hours, about 6 hours, about 12 hours, or about 24 hours. In one embodiment, the clearing step is performed in about 2 minutes to about 1 hour. In one embodiment, the clearing step is performed in about 2 minutes. In one embodiment, the clearing step is performed in about 30 minutes. In one embodiment, the clearing step is performed in about 12 hours.

In one embodiment, the clearing step further comprises the step of adding a solvent to the sample prior to adding the clearing solution. In some embodiments, the solvent is an organic solvent. In one embodiment, the solvent is an alcohol. The alcohol is useful for dehydrating the sample. Non-limiting examples of alcohols include methanol, ethanol, propanol, isopropanol, butanol, isobutanol, ethyl butanol, t-butanol, dioxane, ethylene glycol, acetone, and amyl alcohol. In a preferred embodiment, the solvent is methanol. In one embodiment, the solvent is added in combination with a permeation enhancer. Non-limiting examples of permeation enhancers include acetic acid, polyethylene glycol (PEG), mono- and dimethyleneglycol, propylene glycol, polyvinyl pyrrolidone, or the like, surfactants such as dimethyl sulfoxide (DMSO), polyoxyethylene sorbitan esters (e.g., TWEEN such as TWEEN 80), sodium dimethyl sulfosuccinate, mild household detergents, or the like. In one embodiment, the permeation enhancer is selected from the group consisting of acetic acid, DMSO, and TWEEN. The addition of a solvent in combination with a permeation enhancer increases the rate of clearing with BABB by improving miscibility and permeability, and also eliminates the need for gradual gradient steps of decreasing alcohol concentration.

In part, the present invention provides a method of rapidly processing a tissue sample. The length of time can generally be any length of time suitable for fixing the sample and clearing the sample. The length of time can also generally be any length of time suitable for fixing a portion of the sample and clearing a portion of the sample. In certain embodiments, the period of time may be from about 1 minute, about 5 minutes, about 10 minutes, about 15 minutes, about 30 minutes, about 1 hour, about 2 hours, about 3 hours, about 4 hours, about 5 hours, or about 6 hours. In one embodiment, the steps of fixing the sample and clearing the sample are performed in about 1 hour to about 2 hours. In one embodiment, the steps of fixing the sample and clearing the sample are performed over a period of time about 1.5 hours.

In another aspect, the method of the present invention further comprises the step of imaging the sample. In one embodiment, the step of imaging the sample further comprises producing a visual image of the tissue sample. The sample may be imaged using any imaging method compatible with the sample processing methods described herein. Preferred imaging methods include fluorescence based sectioning imaging methods. Contrary to destructive 3-D histology approaches such as pigmented plastic embedding systems and whole slide imaging (WSI), these fluorescence based methods are non-destructive, allowing for the preservation of samples for ancillary studies such as immunostains and molecular studies. Examples of fluorescence based sectioning imaging methods include, but are not limited to, multiphoton microscopy (MPM), side-plane illumination microscopy, traditional confocal microscopy, spinning disk confocal microscopy, structured illumination microscopy, and the like. In animal tissue (Parra et al., 2010, J. Biomed. Opt. 15:036017-036017-5; Vesuna et al., 2011, J. Biomed. Opt. 16:106009-106009-6; Fu et al., 2009, Gastroenterology 137:453-465), the depth of imaging can be increased over samples prepared using more traditional methods, such as formalin fixing, by combining MPM with optical clearing. In one embodiment, the sample is imaged using multiphoton microscopy (MPM). In another embodiment the sample is imaged using confocal microscopy. In another embodiment, the sample is imaged using structured illumination microscopy. In another embodiment the sample is imaged using selective plane illumination microscopy. In another embodiment the sample is imaged using deconvolution microscopy. In another embodiment the sample is imaged using super-resolution microscopy. In another embodiment, the sample is imaged using side-plane illumination microscopy. In another embodiment, the sample is imaged using spinning disk confocal microscopy. In one embodiment, the method of imaging a tissue sample comprises the steps of obtaining a tissue sample, contacting the tissue sample with a fixative solution comprising at least one fluorescent dye, contacting the tissue sample with a clearing solution, and producing a tissue sample image by measuring intensity values of the fluorescence of the tissue sample, and converting the intensity values to effective optical densities, such that the optical densities recreate the coloration of a stain in a produced image of the tissue sample.

The imaging methods of the present invention provide a method for image analysis that allows reproduction of images essentially indistinguishable from traditional histology stains. In one embodiment, the method involves a multichannel approach, wherein intensity values of fluorescence from the sample are converted to optical densities using an exponential pseudo-coloring process, which is an inversion of a logarithmic pseudo-coloring process, wherein intensity values of fluorescence are converted to optical densities in red, green, and blue channels. In one embodiment, the step of imaging the sample further comprises the steps of measuring intensity values of the fluorescence of the sample, and converting the intensity values to effective optical densities recreate the coloration of a stain in the sample image. In one embodiment, the intensity values of one or more fluorescence channels are converted to effective optical densities in one or more pseudo-color display channels using an exponential pseudo-coloring process, wherein the equation that results in optical densities includes a constant to the power of the intensity values from fluorescence, as would be understood by one of ordinary skill in the art. Numerically:

Ch1=C₁̂(a₁N+b₁P)

Ch2=C₂̂(a₂N+b₂P)

Ch3=C₃̂(a₃N+b₃P)

where Ch1, Ch2, Ch3 are color display channels, such as Red, Green and Blue; C₁, C₂, C₃ are positive constants; a₁, a₂, a₃, b₁, b₂, b₃ are constants that may be positive or negative; and N and P are fluorescence intensities recorded from different fluorescence channels. In one embodiment, the intensity values are converted to effective optical densities using an exponential pseudo-coloration process.

For an example of a logarithmic color deconvolution process, see Ruifrok and Johnston, 2001, Anal. Quant. Cytol. Histol. 23:291-299, which is incorporated by reference herein in its entirety.

In one embodiment, the fluorescence is intrinsic fluorescence from the sample. In another embodiment, the fluorescence is fluorescence from the fluorescent dye. In one embodiment, the fluorescent dye is a nuclear dye. In another embodiment, the fluorescent dye is a protein dye. The number of channels used may be varied as needed to achieve the desired image, as would be understood by one skilled in the art. In one embodiment, the number of channels is two channels. In a specific embodiment, the two channels are an intrinsic fluorescence channel and a fluorescent nucleic acid dye channel. In another embodiment, the two channels are a fluorescent nucleic acid dye channel and a fluorescent protein staining channel. In a non-limiting example, the intrinsic fluorescence, emanating primarily from cross-linked proteins and corresponding to the staining typically achieved by protein stains such as eosin, can be augmented by use of formalin as the fixative, a feature that facilitates the reproduction of normal coloration by improving signal to noise of this channel and facilitating separation from nucleic acid fluorescence.

The imaging method of the present invention also provides images of samples that mimic common pathology stains, resulting in the accurate and efficient interpretation of the images. Examples of pathology stains which can be reproduced using the methods of the present invention include, but are not limited to, hematoxylin, eosin, wright, giemsa, Masson's trichrome, Jones, trichrome, periodic acid Schiff (PAS) and reticulin stains. Combinations of pathology stains can also be reproduced using methods of the present invention. In one embodiment, the combination of pathology stains is hematoxylin and eosin (H&E). In another embodiment, the combination of pathology stains is wright and giemsa.

In some embodiments, the step of imaging the sample is performed in combination with an additional imaging method, resulting in multi-modal imaging. In one embodiment, the additional imaging method is a higher-order harmonic generation. Higher-order harmonic generation permits the recreation of additional specialized histological stains, such as collagen stains like trichrome and silver stains like Jones stain. In one embodiment, the higher order harmonic generation is second harmonic generation (SHG). SHG results from multiphoton excitation of asymmetric repeating proteins such as collagen, and may be used for simple identification and quantification of collagen fibrosis and amyloid in combination with the imaging method, such as MPM. In one embodiment, the additional imaging method is Fluorescence Lifetime Imaging. Fluorescence Lifetime Imaging may be used to provide additional contrast in MPM by distinguishing between fluorophores with differing lifetime characteristics. In another embodiment, the additional imaging method uses multiple fluorescent antibodies. Multiple fluorescent antibodies may be used to provide potential for performing immunohistochemistry in uncut samples with multiple antigens detectable on the same cells. In another embodiment, the imaging method is used in combination with diode lasers. See Dechet et al., 2003, J. Urol. 169:71-74 and Durfee et al., 2012, Opt. Express 20:13677-13683, each which is incorporated by reference herein in its entirety. Other techniques known in the art to increase the rate of scanning of the sample image may be used in the imaging step, as would be understood by one of ordinary skill in the art. Non-limiting examples include multibeam scanning systems, spatiotemporal multiplexing, and temporal focusing. See Bewersdorf et al., 1998, Opt. Lett. 23:655-657, Amir et al., 2007, Opt. Lett. 32-1731-1733, Oron et al., 2005, Opt. Express 13:1468-1476, and Zhu et al., 2005, Opt. Express 13:2153-2159, each which is incorporated by reference herein in its entirety. In another embodiment, the imaging step is performed in real time using video imaging.

The methods of the present invention provide a clear, high-quality image of the sample obtained at a greater sample depth as compared with more traditional histological methods, such as sample treated only with formalin fixation. In one embodiment, the sample image is obtained at a sample depth of about 100 nm to about 2 cm. In another embodiment, the sample image is obtained at a sample depth of about 100 nm to about 500 μm. In another embodiment, the sample image is obtained at a sample depth of about 100 nm to about 1 cm. In another embodiment, the sample image is obtained at a sample depth of about 50 μm to about 500 μm. In another embodiment, the sample image is obtained at a sample depth of about 100 nm to about 100 μm. In another embodiment, the sample image is obtained at a sample depth of about 200 μm. In another embodiment, the sample image is obtained at a sample depth of about 100 μm.

In one embodiment, imaging of the sample provides digital sample data. This digital data may then be stored for later distribution, such as for consultation and health records, thereby improving the accessibility of the images for further evaluation or reevaluation. In addition, digital sample data is capable of maintaining the integrity of the data, as opposed to physical samples which may be lost or damaged and cannot be stored digitally.

In one embodiment, the sample image is a three dimensional (3-D) sample image. A 3-D sample image can be produced using any method known in the art, as would be understood by one skilled in the art. In one embodiment, the 3-D sample image is produced from an entire biopsy. In another embodiment, a 3-D sample image produced from a whole biopsy provides a quantitative approach to diagnosing a disease. In another embodiment, a 3-D sample image of the present invention provides facile identification of subtle morphologic findings in the imaging sample. For example, 3-D sample images improve the quantitative and qualitative analysis of fibrosis observed in various conditions such as cirrhosis, hypertensive renal disease, interstitial lung disease, and ovarian cancer over other two-dimensional (2-D) histological methods currently known in the art. In another embodiment, a 3-D sample image of the present invention is used to diagnose a malignant growth. In one embodiment, the methods of the present invention provide full rotational control of 3-D sample images. Diagnosis of malignant growth is often dependent on visualizing growth patterns, particularly in glandular-based disorders such as prostate and breast cancer. Such analysis has been primarily based on the two-dimensional orientation, which may require pathologists to look back-and-forth at (hopefully) contiguous segments in order to render a diagnosis. In these 2D methods, visual inspection can be further complicated by poor embedding and orientation differences of the sample. In non-limiting examples, the 3-D sample images of the present invention are used to diagnose metastatic colon cancer in liver and for the diagnosis of endometrial abnormalities. In another non-limiting example, 3-D reconstructions of MPM imaging from clarified tissue may be used on complete biopsy-sized tissue specimens and may also be used to produce quantifiable characterization of collagen fibrosis. Other non-limiting examples of the use of 3-D sample image include identification of low-grade abnormalities in glandular cell growth, such as with prostate and breast neoplasia, the evaluation of depth of invasion of tumors, such as for determining depth of muscle invasion in bladder biopsies, and the more complete quantitative evaluation of fibrosis, of particular significance in kidney and liver biopsies.

### Specimen Holding Device

In another aspect, the invention relates to a specimen holding device. The device is useful for holding a histological sample and facilitates processing and imaging the histological sample. In one embodiment, the device is amenable for use in the methods of the present invention as described elsewhere herein.

Referring now to FIG. 1, an exemplary specimen holding device 10 is depicted. Specimen holding device 10 comprises a first plate 12 and a second plate 18. First plate 12 comprises window 14, compressible material 16, and tabs 20. Second plate 18 comprises window 14 and slots 22.

First plate 12 and second plate 18 may comprise any suitable material. For example, first plate 12 and second plate 18 comprise a substantially rigid material, such as glass, metal plastic, and the like. First plate 12 and second plate 18 may comprise any suitable dimensions. In one embodiment, first plate 12 and second plate 18 comprise the same length 11 and width 13. In one embodiment, first plate 12 and second plate 18 are dimensioned such that they fit on any microscope stage. For example, in one embodiment, length 11 can be between 40 mm and 100 mm. In another embodiment, width 13 can be between 20 mm and 80 mm. In one embodiment, length 11 is 75 mm and width 13 is 25 mm.

Specimen holding device 10 comprises window 14 for holding and viewing specimens. Window 14 may comprise any suitable material. For example, window 14 may comprise a transparent material, such as glass or clear plastic. In certain embodiments, window 14 may comprise any other substantially rigid material, such as a metal or an opaque plastic. In one embodiment, both first plate 12 and second plate 18 comprise a transparent window 14. In another embodiment, only first plate 12 comprises a transparent window 14. In a further embodiment, only second plate 18 comprises a transparent window 14.

First plate 12 comprises compressible material 16. Compressible material 16 is placed atop first plate 12. In one embodiment, compressible material 16 is glued or otherwise fastened to first plate 12. In one embodiment, compressible material 16 is dimensioned such that it forms a perimeter. For example, compressible material 16 can form the perimeter of the shape of window 14. In another embodiment, compressible material 16 is dimensioned such that it is a sold block. For example, compressible material 16 can be a solid block have the shape of window 14. Compressible material 16 can comprise any suitable material including, but not limited to: foams, rubbers, sponges, polymers, cork, and the like. In one embodiment, compressible material 16 comprises gaps or slits such that fluids are able to pass through it. In another embodiment, compressible material 16 comprises a porous material to allow fluids to pass through it. Non-limiting examples of porous materials include, but are not limited to: solid foams, sponges, plastic meshes, and the like. The pore size of the porous material may be selected to control the rate of fluid transfer. For example, the pore size can be between 10 μm and 1 mm in diameter.

First plate 12 comprises a mechanism by which to hold it at a fixed distance from second plate 18. In one embodiment, the mechanism comprises a tab and reciprocal slot. For example, first plate 12 can comprise at least two tabs 20, and second plate 18 can comprise at least two slots 22. In another embodiment, first plate 12 can comprise at least two slots, and second plate 18 can comprise at least two tabs. In one embodiment, the number of tabs 20 matches the number of slots 22. Tabs 20 are dimensioned such that they fit within slots 22. In one embodiment, tabs 20 comprises teeth 24 such that when tab 20 engages slot 22, teeth 24 provide frictional resistance to secure tab 20 within slot 22. In a further embodiment, teeth 24 provide frictional resistance to reversibly secure tab 20 within slot 22.

### Method of Using the Specimen Holding Device

In another aspect, the invention relates to methods for securely holding a specimen for sample processing. The invention also relates to methods for securely holding a specimen for imaging.

In one embodiment, the method uses specimen holding device 10 for securely holding a specimen for sample processing. In one embodiment, a specimen may be placed on window 14 of first plate 12, such that the specimen is surrounded by a perimeter comprising compressible material 16. Second plate 18 is secured to first plate 12 by engaging tabs 20 to slots 22, such that compressible material 16 fully contacts second plate 18. In one embodiment, the specimen is not compressed against any surface when first plate 12 and second plate 18 are secured together. A compressible material 16 comprising porous material allows for fluid transfer into and out of the specimen holding device during sample processing. For example, the specimen holding device may be fully submerged in a sample processing fluid to incubate the specimen in the fluid.

In another embodiment, the specimen is placed on a solid block of compressible material on first plate 12 (not pictured). Second plate 18 is secured to first plate 12 by engaging tabs 20 to slots 22, such that the solid block of compressible material presses against second plate 18. A solid block of compressible material comprising a porous material allows for fluid transfer throughout the block and for fluids to contact the specimen during sample processing. For example, the specimen holding device may be fully submerged in a sample processing fluid to incubate the specimen in the fluid.

In one embodiment, the method uses specimen holding device 10 for securely holding a specimen for imaging. A specimen is placed on window 14 of first plate 12, such that the specimen is surrounded by a perimeter comprising compressible material 16. Second plate 18 is secured to first plate 12 by engaging tabs 20 to slots 22. Second plate 18 may be lowered onto the specimen such that the specimen is compressed against window 14 of both first plate 12 and second plate 18. Being compressed against both windows 14, the specimen is thereby immobilized. Specimen holding device 10 may then be placed on any suitable imaging system, and the specimen may be imaged through at least one of window 14.

In another embodiment, the specimen is placed on a solid block of compressible material 16 on first plate 12 (not pictured). Second plate 18 is secured to first plate 12 by engaging tabs 20 to slots 22. Second plate 18 may be lowered onto the specimen such that the specimen is compressed against the solid block of compressible material 16 on first plate 12 and window 14 of second plate 18, thereby immobilizing the specimen. Specimen holding device 10 may then be placed on any suitable imaging system, and the specimen may be imaged through window 14.

### Microscope System

In another aspect, the invention relates to a microscope system for 2-D and 3-D imaging of specimens. In one embodiment, the microscope system is amenable for use in the methods of the present invention as described elsewhere herein.

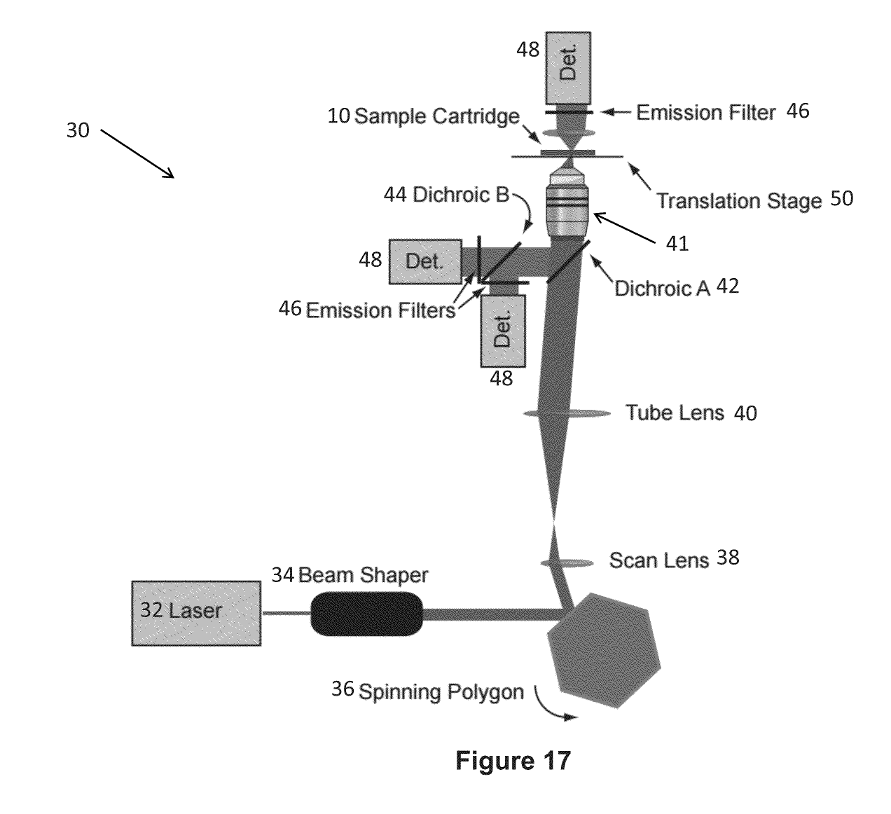

Referring now to FIG. 17, an exemplary microscope system 30 is depicted. Microscope system comprises laser 32, an optional beam shaper 34, spinning polygon 36, scan lens 38, tube lens 40, microscope objective 41, dichroic mirror A 42, dichroic mirror B 44, a plurality of emission filters 46, a plurality of detectors 48, and translation stage 50. Microscope system 30 may further comprise any component customarily used in other similar microscope systems, such as viewfinders, power sources, stage manipulation mechanisms, autofocus mechanisms, automation systems, and the like.

Laser 32 comprises a laser source providing, for example, multiphoton excitation of dyes used in sample labeling. Laser 32 may comprise any suitable laser, such as femtosecond or picosecond pulsed fiber laser, or any other short-pulse laser with a center wavelength that is adjustable for optimum excitation of dyes. Alternatively, the center wavelength may be non-tunable but may be chosen to correspond to a wavelength suitable for exciting dyes used to stain a sample. In one embodiment, the center wavelength is 800 nm.

A laser beam being emitted by laser 32 passes through beam shaper 34. In one embodiment, beam shaper 34 expands the laser beam to a width required to illuminate the back aperture of microscope objective 41. In another embodiment, beam shaper 34 may transform the laser beam profile. For example, a laser beam having a Gaussian beam profile may be transformed to have a flat top profile after passing through beam shaper 34, which results in more efficient illumination of the back aperture of microscope objective 41.

A laser beam passing through beam shaper 34 is rapidly scanned in angle by spinning polygon 36 having a plurality of mirrored facets. In various embodiments, the laser beam may be rapidly scanned in angle by any one of several resonant scanning mechanisms commonly available for rapid beam scanning Non-limiting examples of resonant scanning mechanisms used for rapid beam scanning include resonant galvanometers and digital micromirror devices.

A rapidly scanned laser beam is imaged to the back aperture of microscope objective 41 using scan lens 38 and tube lens 40. In one embodiment, scan lens 38 is a telecentric lens. In one embodiment, scan lens 38 is an F-theta lens. In various embodiments, scan lens 38 can be any suitable lens that images an angle-scanned beam from the surface of spinning polygon 36 to the back aperture of microscope objective 41 when used in conjunction with tube lens 40.

In one embodiment, microscope system 30 comprises dichroic mirror A 42, such that fluorescent light collected by the objective lens may be reflected by dichroic mirror A to be collected by one or more detectors 48. Alternatively, the beam path may be chosen such that dichroic mirror A is used to reflect the excitation laser beam to the back aperture of a microscope objective to transmits the collected fluorescence to detectors 48. In one embodiment, fluorescence or SHG may be collected as transmitted light with or without a collecting lens (not pictured) and detectors 48. Detectors 48 may be any detector sensitive to appropriate wavelengths. For example, in one embodiment detectors 48 may comprise photomultiplier tubes. Microscope system 30 may further comprise dichroic mirror B 44, or any number of additional dichroic mirrors as is needed to send different color fluorescence to different detectors 48. In one embodiment, microscope system 30 may further comprise any number of emission filters 46 as is needed, wherein emission filters 46 placed in front of detectors 48 reject stray laser light and other light interference.

In various embodiments, microscope system 30 comprises at least one microscope objective 41. In one embodiment, microscope objective 41 is compatible with high-refractive-index immersion medium. In various embodiments, microscope objective 41 is compatible with a high-refractive-index immersion medium having an index between 1.45 and 1.6. In one embodiment, microscope objective 41 is compatible with a high-refractive-index immersion medium having an index of 1.54. In one embodiment, microscope objective 41 is compatible with an immersion medium that is the BABB clearing agent as disclosed elsewhere herein. In one embodiment, microscope system 30 having an inverted microscope arrangement comprises a microscope objective 41 with a relatively broad and flat aspect on the side that faces a sample such that immersion fluid can be easily maintained between microscope objective 41 and sample cartridge 10.

In one embodiment, microscope objective 41 comprises a numerical aperture for high quality optical axial sectioning with a short depth-of-field. In one embodiment, the numerical aperture is at least 0.8. In another embodiment, the numerical aperture is at least 1.0.

In one embodiment, microscope objective 41 comprises a large field of view for imaging a sample. In one embodiment, microscope objective 41 has a field of view that is 20×. In another embodiment, microscope objective 41 has a field of view that is greater than 20×.

Samples may be placed on translation stage 50 for imaging. The position of translation stage 50 relative to microscope objective 41 may be adjusted to any position for imaging different regions of samples and for adjusting focus. For example, in various embodiments, translation stage 50 may be adjusted such that the working distance between microscope objective 41 and a sample is between 100 μm and 2 mm. In one embodiment, the working distance may be adjusted to be at least 100 μm to achieve sufficient depth such that complete optical sections may be obtained in samples with significant peaks and valleys from surface irregularities.

### Methods of Using the Microscope System

In another aspect, the invention relates to methods of imaging samples using the microscope system of the present invention. The method passes a laser beam through microscope system 30 such that microscope objective 41 focuses the laser beam upon a single point on a sample placed on translation stage 50. In some embodiments, spinning polygon 36 causes the laser beam to rapidly scan a line across the sample. In other embodiments, a resonant galvanometer directs the laser beam to rapidly scan a line across the sample.

In one embodiment, the laser beam is rapidly scanned across the sample in a stepped linear fashion (raster scan), such that successive scans produces a rectangular 2-D image. In a further embodiment, the translation stage may be moved along the imaging plane after a rectangular 2-D image is obtained such that a second rectangular 2-D image may be obtained by rapidly scanning the laser beam across the sample in a stepped linear fashion. The translation stage may be moved along the imaging plane in further incremental steps such that a plurality of rectangular 2-D images are obtained, until a full cross-section of the specimen at a given imaging plane has been interrogated. The plurality of rectangular 2-D imagines are stitched together using any method known in the art, such as with microscopy software, to create a full cross-section image of the sample. In one embodiment, 2-D images having partial overlap aids the automatic assembly of the cross-section of the sample.

In further embodiments, the specimen may be translated axially relative to objective 41 so that the process of obtaining 2-D images at a given image plane may be repeated, representing a different cross sectional image of the sample. In one embodiment, successive rectangular 2-D image cross-sections are obtained until the full volume of the sample has been interrogated.

### Kits of the Invention

The invention also includes a kit comprising components useful within the methods of the invention and instructional material that describes, for instance, the method of processing tissue samples as described elsewhere herein. The kit may comprise reagents useful for performing the methods of the invention. For instance, the kit may comprise reagents such as fixatives, dyes, and clearing solutions. The kit may further comprise devices useful for performing the methods of the invention. For instance, the kit may comprise the specimen holding device and the microscope system of the invention, as described elsewhere herein.

In one embodiment, the reagents are provided in concentrated form, such that the weight and size of the kit can be reduced and the solutions need only be diluted for immediate use. In another embodiment, the kit further comprises (preferably sterile) the components of the reagents in lyophilized form. For instance, the components may be in premeasured amounts suitable for reconstitution and immediate use. The kit can further include one or more additional component, such as reconstitution containers, and additional reagents such as deionized water, wash buffer, and the like.

In certain embodiments, the kit comprises instructional material. Instructional material may include a publication, a recording, a diagram, or any other medium of expression which can be used to communicate the usefulness of the device or kit described herein. The instructional material of the kit of the invention may, for example, be affixed to a package which contains one or more instruments which may be necessary for the desired procedure. Alternatively, the instructional material may be shipped separately from the package, or may be accessible electronically via a communications network, such as the Internet.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

### Example 1

### High-Resolution, 2- and 3-Dimensional Imaging of Uncut, Unembedded Tissue Biopsy Samples

The results described herein demonstrate that the combination of clearing agents and fluorescent dyes is useful for clinical application of multiphoton imaging of complete biopsy specimens, along with added informational content from SHG. Excellent cellular contrast can be achieved from both intrinsic fluorescence and with extrinsic nucleic acid dyes. Multichannel imaging facilitated a pseudocolorization process that mimicked the appearance of traditional stains. Three-dimensional reconstructions of MPM imaging from clarified tissue may be used on complete biopsy-sized tissue specimens and may also be used to produce quantifiable characterization of collagen fibrosis.

The materials and methods employed in these experiments are now described.

### Tissue Clearing and Staining

Human tissue specimens were obtained from discarded pathologic tissue of liver, kidney, breast, and prostate resections. Samples had been fixed in 4% formaldehyde solution before clearing for a variable period of time ranging from hours to days. Random tissue sections of approximately 1 cm×5 mm×2 mm were immersed directly in methacarn containing 10 uM DAPI and 0.5% by volume eosin for 1 hour. Subsequently samples were immersed in benzyl alcohol/benzyl benzoate in a 1:2 ratio for 1 hour.

### Imaging

Multiphoton images, including intrinsic fluorescence, nuclear fluorescent staining, and SHG, were obtained by using a custom home-built microscope based on a tunable 80-MHz-pulsed Ti:Sapphire laser (Mai Tai, Spectra-Physics, Mountain View, Calif.), a 3-axis motorized microscope stage (ASI Imaging, Eugene, Oreg.), and an Olympus BX51 upright microscope head fitted with an ×5 Nikon objective with a numerical aperture of 0.5 (AZ-Plan Fluor 5×, Nikon Corp, Tokyo, Japan).

Both intrinsic and nucleic acid dye fluorescence were generated by using 740-nm incident light with a pulse width of 100 fsec. A 500-nm wavelength dichroic mirror separated intrinsic from exogenous fluorescence, both detected by using photomultiplier tubes (H7422, Hamamatsu, Bridgewater, N.J.). The microscope head incorporates a modified optical collection filter box to accommodate the photomultiplier tubes. Second-harmonic generation was collected in transmission by using a 370/20 bandpass filter (Chroma Technologies, Rockingham, Vt.). An adjustable 3-axis mount (New Focus, Santa Clara, Calif.) was used to manually position the SHG photomultiplier tube (Hamamatsu HC-125-02).

Control and image collection were performed with the use of Scanlmage software (Howard Hughes Medical Institute, Janelia Farm Research Campus, Ashburn, Va.)(Pologruto et al., 2003, Biomed. Eng. Online 2:13). Focusing was done at 512×512 resolution with 1 millisecond per line scan times, giving a frame rate of approximately 2 frames per second. Image resolution at collection was 2056×2056 or 1024×1024 at a zoom factor of 1 to 6, depending on desired magnification. Between 4 and 8 frames were averaged per slice for a total acquisition time of 20 seconds per slice. Incident laser intensity was manually adjusted via a Pockels cell in the excitation pathway. Stacks were collected in 1- to 5-μm steps at 16-bit depth and processed by using ImageJ software (developed at the National Institutes of Health, Bethesda, Md.). Total imaging time for 1 mm cube reconstructions was approximately 6 hours. Post-image processing involved conversion to 8-bit, image inversion, manual global contrast adjustment using the built-in “brightness/contrast” plug-in on a random sample section, and application of the built-in “smooth” function.

Pseudo-coloring was performed by inverting the matrix conversion process presented by Ruifrok and Johnston (Ruifrok and Johnston, 2001, Anal. Quant. Cytol. Histol. 23:291-299). Briefly, intensity values from intrinsic fluorescence and nuclear stains were converted to optical densities in red, green, and blue channels according to the published matrix values for H&E by using MATLAB (MathWorks, Natick, Mass.). Intrinsic fluorescence intensity was assigned to the eosin channel (E) while nucleic acid stains were assigned to the hematoxylin channel (H). Following image normalization and scaling to achieve adequate contrast, the red (R), green (G), and blue (B) channel values for the combined pseudocolored images were calculated as follows:

R=10̂(−(0.644E+0.093H))

G=10̂(−(0.717E+0.954H))

B=10̂(−(0.267E+0.283H))

### Traditional Histology

Paraffin embedding, sectioning, and H&E staining were performed by using established techniques with a Tissue-Tek VIP tissue processor (Sakura, Torrance, Calif.). Immunohistochemical stains for cytokeratin (CK) 7 and CK20 used commercial antibodies and were performed with standard commercial immunohistochemistry equipment (Dako, Glostrup, Denmark).

The results of the experiments are now described.

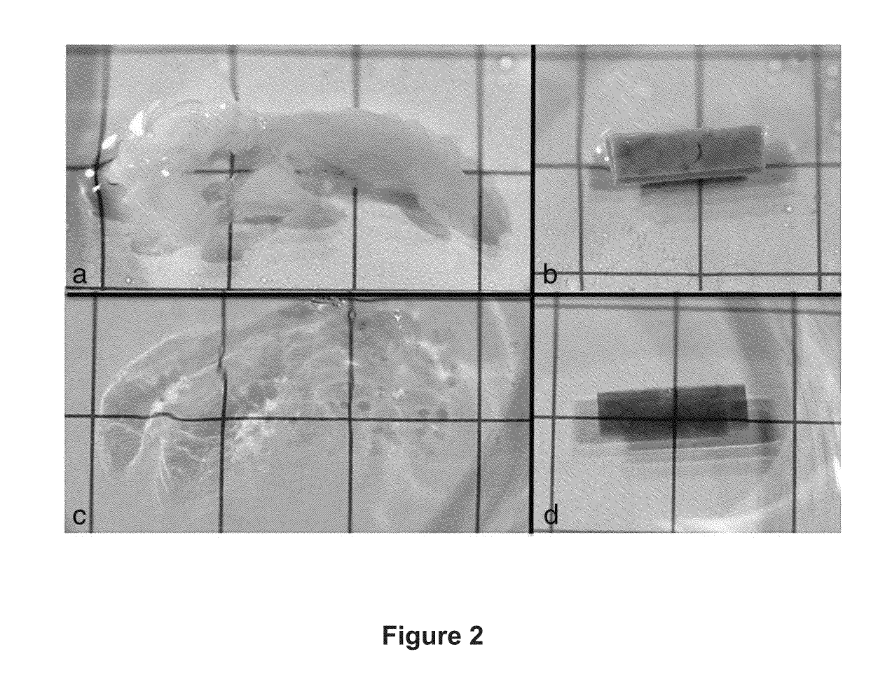

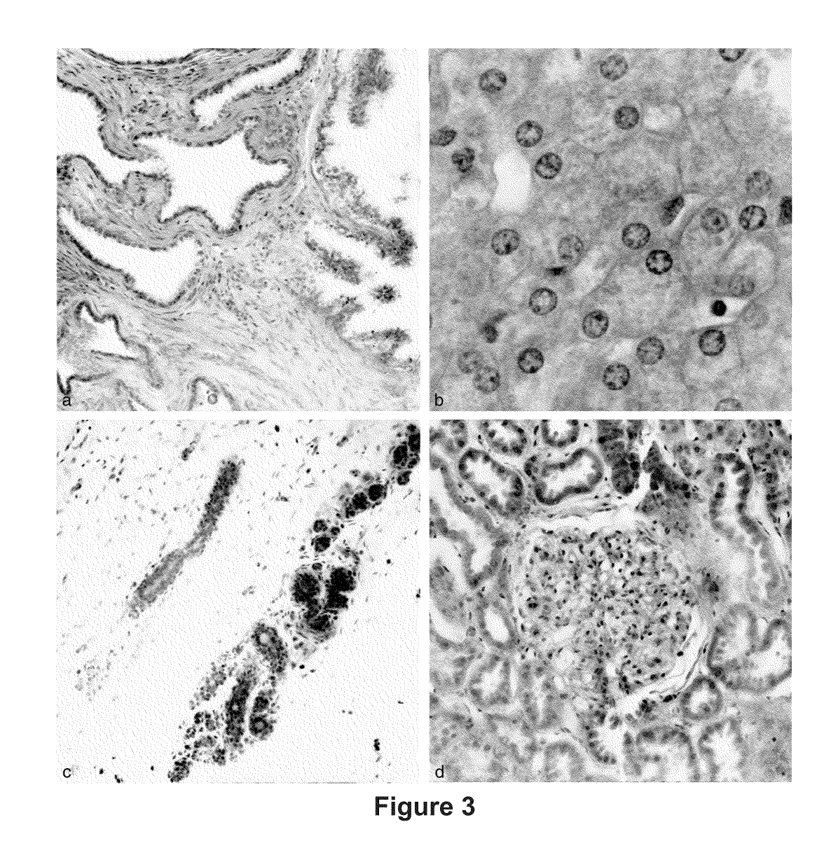

Clearing allowed imaging with excellent cellular and nuclear resolution of SYTOX Green or acridine orange-stained specimens more than 500 μm deep into formalin-fixed human prostate, liver, breast, and kidney samples (FIGS. 2-3). Multiphoton images showed readily identifiable features, comparable to cut slices of H&E-stained tissue, that were amenable to visual pathologic diagnosis without additional morphology training Normal prostatic glandular structure was readily visualized with adequate nuclear detail (FIG. 3A). Similarly, high-power views of liver tissue produced recognizable chromatin patterns and cytoplasmic detail (FIG. 3B). Breast virtual sectioning showed distinguishable tubular and glandular organization (FIG. 3C). Kidney samples showed clear glomerular structure and visible nuclear and cellular detail in adjacent tubules (FIG. 3D). Clearing was most complete in less cellularly dense tissues such as breast and prostate, but with the BABB clearing protocol even kidney and liver cleared sufficiently to show good morphologic detail 1 mm deep into formalin-fixed tissue.

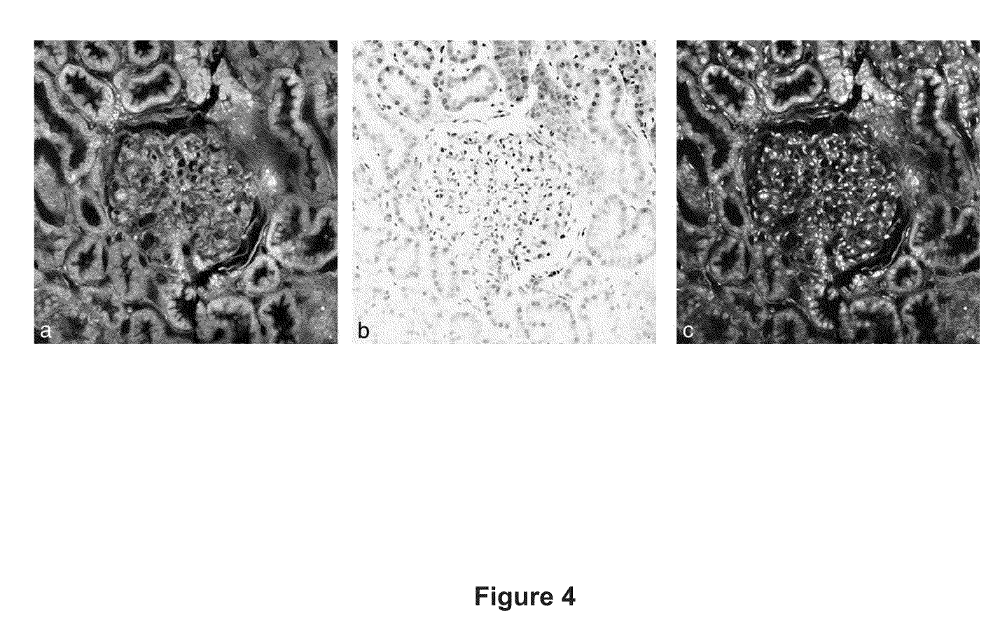

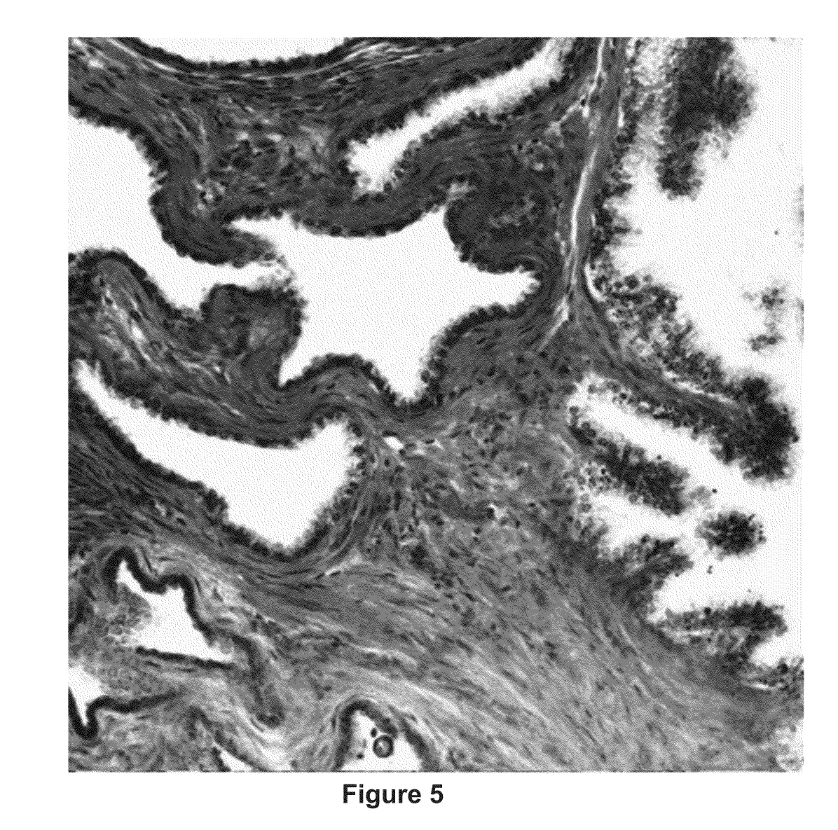

Multiphoton laser excitation and use of a fluorescent nuclear dye also allowed isolation of cytoplasmic, nuclear, and collagen components of the specimens. For example, as illustrated with kidney images presented in FIG. 4, intrinsic fluorescence corresponded to the cellular structure and allowed clear evaluation of the glomerular vasculature and tubular cellular organization (FIG. 4A). The nucleic acid stain channel allowed independent evaluation of nuclei (FIG. 4B). Combining these 2 channels with the SHG by intervening collagen strands (pseudocolored in red) allowed clear visualization of the low-level collagen banding that is present in normal human kidney (FIG. 4C). It was also possible to replicate H&E-type coloration on fluorescently stained sample images obtained with MPM (FIG. 5). The multiple channels could be individually matched to corresponding hues that mimic the effect of H&E.

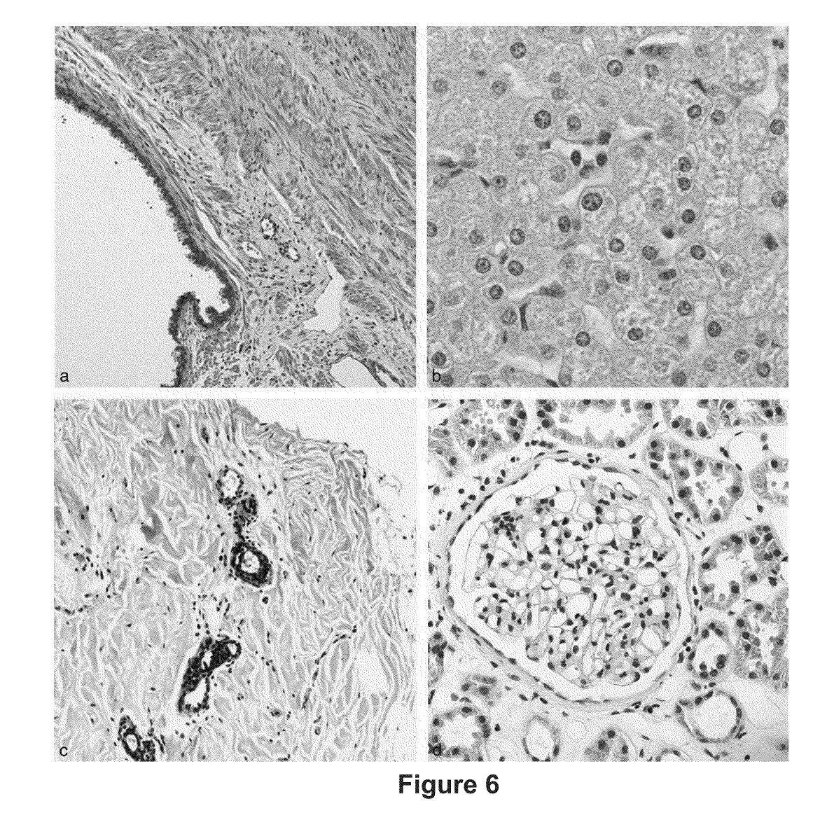

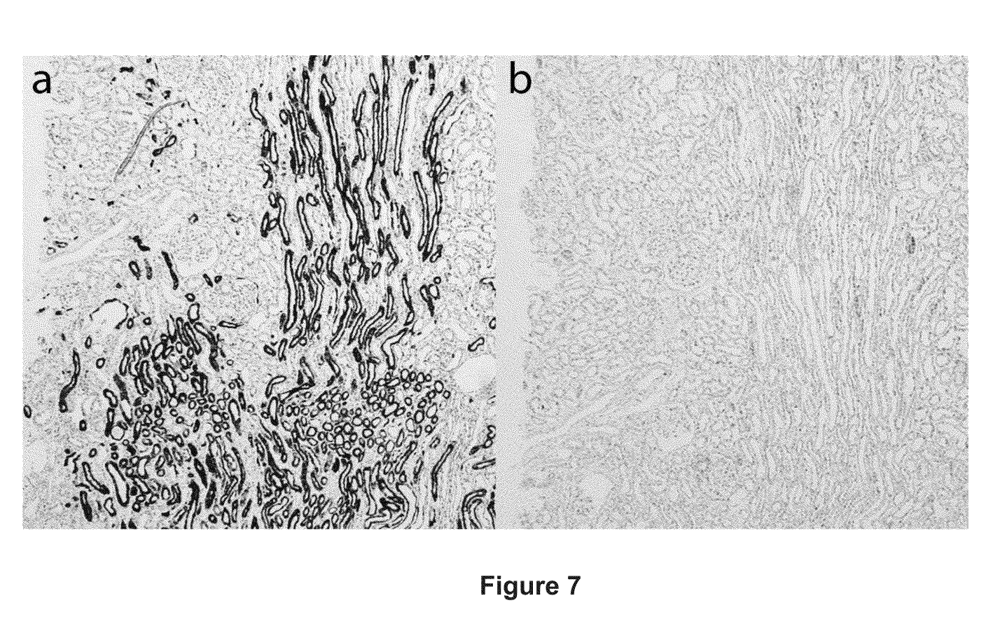

Clearing and fluorescent staining did not have any detectable effect on the subsequent paraffin embedding, sectioning, and H&E staining of the tissues. The same specimens shown in FIG. 3 were further processed by traditional histologic techniques and showed no identifiable morphologic adverse effects (FIG. 6). In addition, immunohistochemical staining of kidney tissue for CK7 and CK20 showed the expected specificity of CK7 for descending medullary renal tubules without binding of CK20 (FIG. 7). Thus, the sensitivity and specificity of these antibodies were clearly maintained after the use of BABB as a clearing agent and SYTOX Green or acridine orange as a fluorescent nuclear stain.

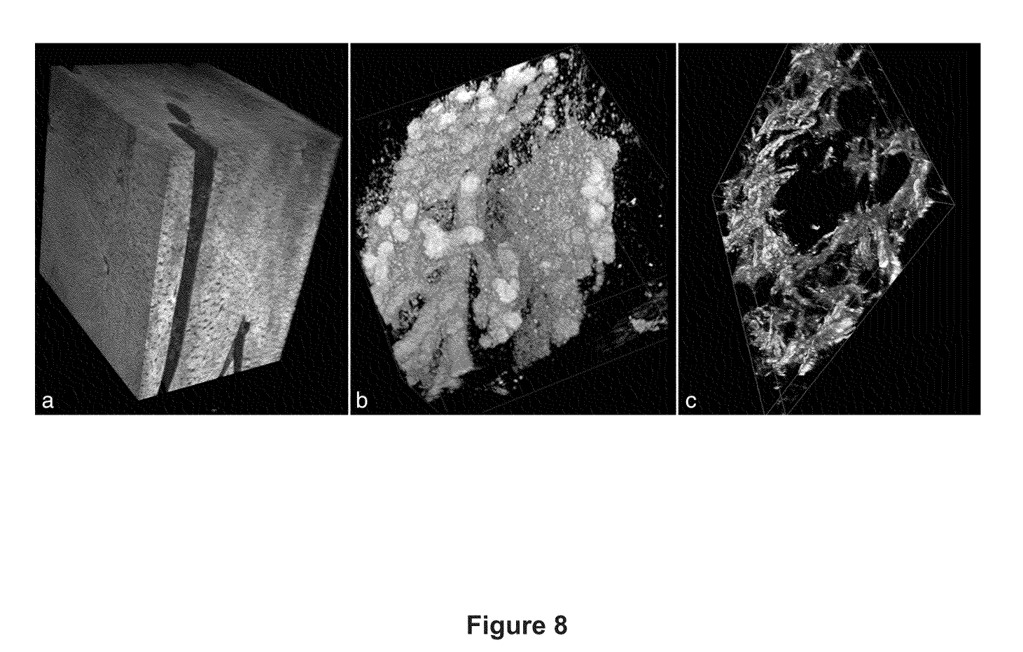

The acquisition of digital images also allowed 3-dimensional reconstruction of 1-mm-thick blocks of tissue. Full-scale 3-D reconstructions of intrinsic fluorescence of liver provide a more complete perspective on normal tissue growth, as illustrated in the liver reconstruction presented in FIG. 8A. The potential for accurate evaluation of neoplastic growth margins is apparent. Nuclear fluorescence scans taken every 4 μm also allowed visualization of the arborizing structure of breast glands as noted in FIG. 8B. The transparency of collagen fibers and fat to the nuclear dye wavelengths facilitated these large set reconstructions, which could be easily rotated and manipulated with the ImageJ 3-D volume-rendering plug-in on a standard 64-bit laptop computer. In addition, 3-dimensional reconstructions of SHG signal in liver and kidney (FIG. 8C) demonstrate the ability to perform complete specimen quantitative analysis of fibrosis without the need for additional tissue processing. As expected, SHG was brighter toward the portion of the tissue distal to laser excitation (closest to detector), but produced resolved collagen detail throughout 1-mm-thick tissue.

Traditional techniques of fixation with formalin with physical wax embedding and microtome sectioning for histology have been successfully used in routine pathology evaluation for more than a century. Part of their success can be attributed to the ease of use and forgiving nature of formalin fixation, coupled with the compatibility of wax embedding with a range of simple and inexpensive staining techniques. Other important factors for the continued success of formalin-fixed, wax-embedded slides have been the long-term preservation that formalin fixation affords and the cumulative experience of pathologists, which increases the accuracy and consistency of interpretation.

Nonetheless, there remain considerable limitations associated with current specimen processing methods and the evaluation of these by pathologists. For biopsies, these include the limited amount of tissue that is typically directly visualized, a function of both the desire to preserve tissue for ancillary testing and the time required to inspect multiple slides. Not infrequently, additional tissue evaluation is needed, but requests for recuts and levels delay diagnoses. Also, they usually still result in sampling only a portion of the tissue while reducing tissue availability for increasingly important immunostaining and molecular analysis. In addition, imperfect embedding results in tissue waste and can hamper interpretation, and the cutting process itself produces artifacts that may hinder evaluation. Imaging of unembedded and uncut tissue addresses these traditional processing limitations. It provides the opportunity to visualize entire biopsy specimens, reducing the likelihood of missing important features owing to incomplete sampling, and to preserve tissue for ancillary tests.

Other advantages of analyzing uncut, unembedded specimens relate to savings in time and effort. Embedding, cutting, and staining are some of the most time-consuming and manual steps in tissue processing (Busea, 2007, Ann. Diagn. Pathol. 11:206-211; Hassell et al., 2010, BMC Clin. Pathol. 10:2; Busea, 2009, Ann. Diagn. Pathol. 14:107-124), requiring personnel with significant expertise. While automation and microwave-based tissue processing have allowed some sites to begin to offer same-day diagnosis for some biopsy samples, the post-dehydration and clearing steps are an impediment in satisfying an increasing need on the part of providers and patients for rapid turnaround of morphologic evaluation.

Another aspect of interest in tissue biopsy evaluation that was explored is the visualization of 3-dimensional structure. Previous attempts at creating large 3-D data sets from tissue have used methods producing poor contrast, poor depth penetration, or that successively remove tissue as the 3-D volume is imaged (Zysk et al., 2007, J. Biomed. Opt. 12:051403-051403-21; Bizheva et al., 2005, J. Biomed. Opt. 10:11006-11006-07; Ragan et al., 2007, J. Biomed. Opt. 12:014015-014015-9; Dechet et al., 1999, J. Urol. 162:1282-1284). Thus, past 3-D reconstruction techniques failed to improve upon the most important limitations of traditional histology. However, 3-D reconstructions of clarified tissue using MPM showed excellent cellular contrast, sufficient depth, such that entire biopsy specimens could be imaged, and compatibility with subsequent traditional processing, including preservation of immunostain capability with the few antibodies tested.

A critical barrier to clinical adoption of new imaging technologies is resistance from pathologists who have spent years honing their skills on a specific set of specialty stains and the desire to maintain full compatibility with established clinical practice. The MPM/clearing approach has produced images that have resolution and fields of view similar to those of current routine practice and provide contrast similar to that obtained with commonly used histologic stains, but that allow subsequent traditional processing without apparent adverse effects. The multichannel method described herein also allowed straightforward pseudo-colorization that represents morphology in a method analogous to traditional stains, allowing pathologists to easily recognize salient histologic features.

### Example 2

### Exemplary Tissue Staining Protocol

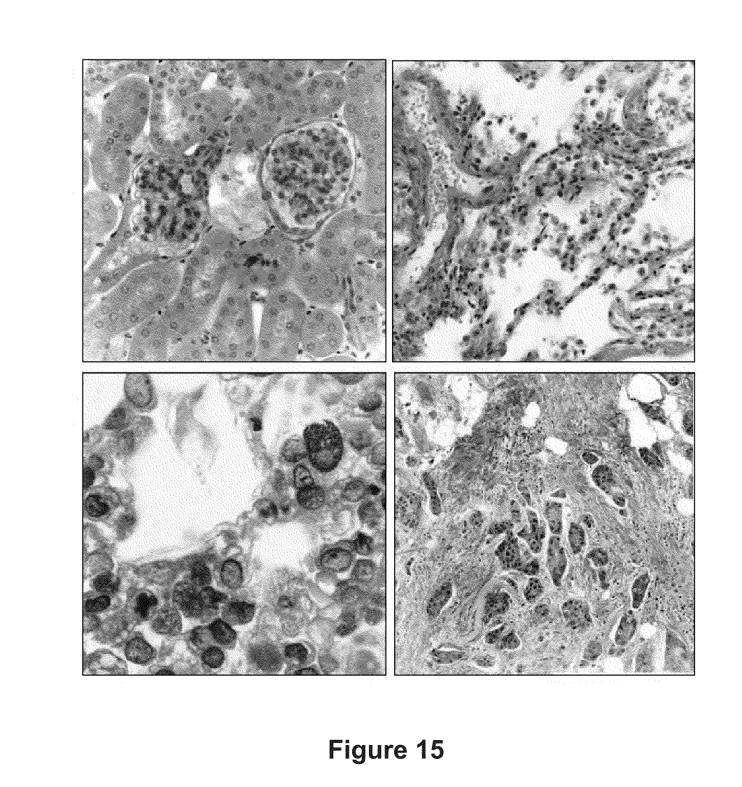

A core biopsy-sized tissue specimen is fixed in formalin for a period of time from 20 minutes to 4 weeks. The specimen is them placed directly in a solution of methacarn which has 10 μM DAPI and 0.5% by volume eosin added to the solution. The specimen is incubated at 45° C. for 60 minutes. The specimen is transferred directly to a solution of 100% BABB, and incubated for 30 minutes. The specimen is imaged in a BABB bath. FIG. 15 depicts images of tissue samples prepared according to this exemplary method.

### Example 3

### Exemplary Tissue Staining Protocol

A core biopsy-sized tissue specimen is placed directly in a solution of methacarn which has 10 μM DAPI and 0.5% by volume eosin added to the solution. The specimen is incubated at 45° C. for 60 minutes. The specimen is transferred directly to a solution of 100% BABB, and incubated for 30 minutes. The specimen is imaged in a BABB bath.

### Example 4

### Exemplary Tissue Staining Protocol

A specimen is fixed in formalin and 10 μM DAPI using traditional methods or rapid formalin fixation methods, such as with a microwave. The specimen is incubated in methacarn at 40° C. for 60 minutes. The specimen is transferred to a solution of 100% BABB, and incubated for 20 minutes. The specimen is imaged in a BABB bath.

### Example 5

### Exemplary Tissue Samples Produced Using the Methods of the Invention

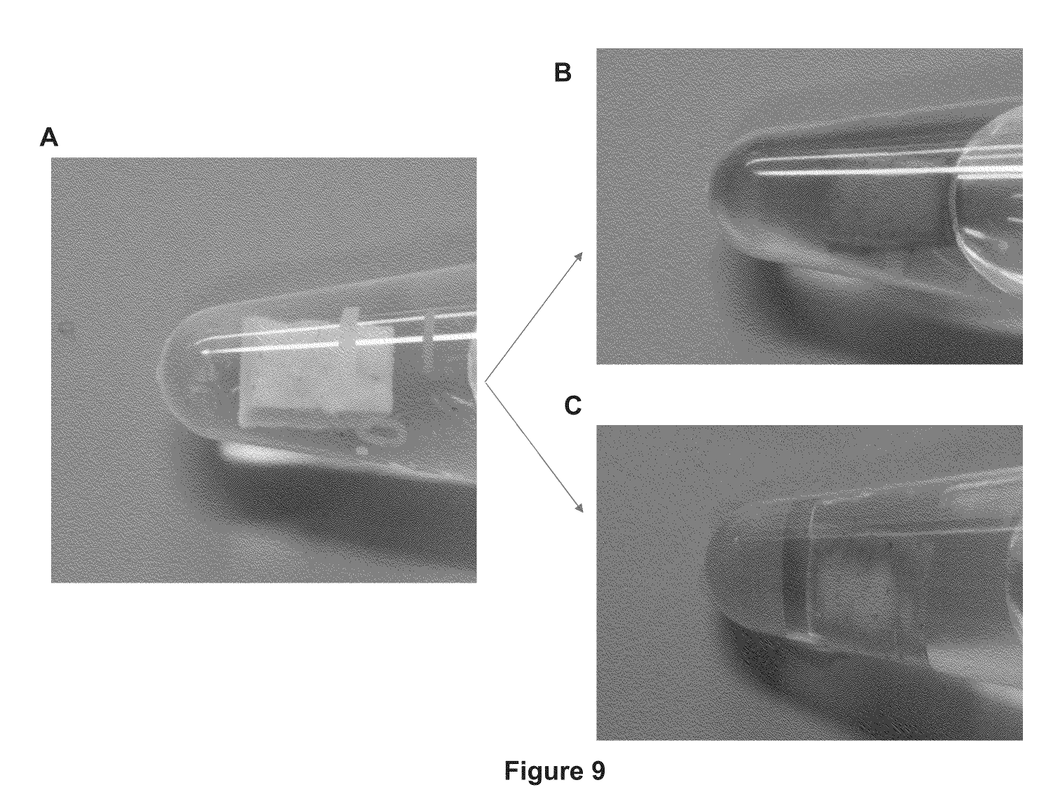

FIG. 9 shows various tissue samples, such as an image of an uncleared sample (FIG. 9A) and sample produced with a traditional ethanol/hexane/BABB method of tissue processing (FIG. 9B). This traditional method was used as a comparative example because it is recognized as being significantly faster than alternative clearing methods which typically take days to weeks for adequate clearing. FIG. 9C is an image depicting a sample processed using the methods of the present invention. At time 1.25 hours (15 mins clearing post processing), clearing with the method of the present invention shows deeper clearing (smaller core of uncleared volume) compared to traditional processing. The traditional method also shows leeching of fluorescent dye into BABB (red tint to liquid), indicative of reduced dye binding.

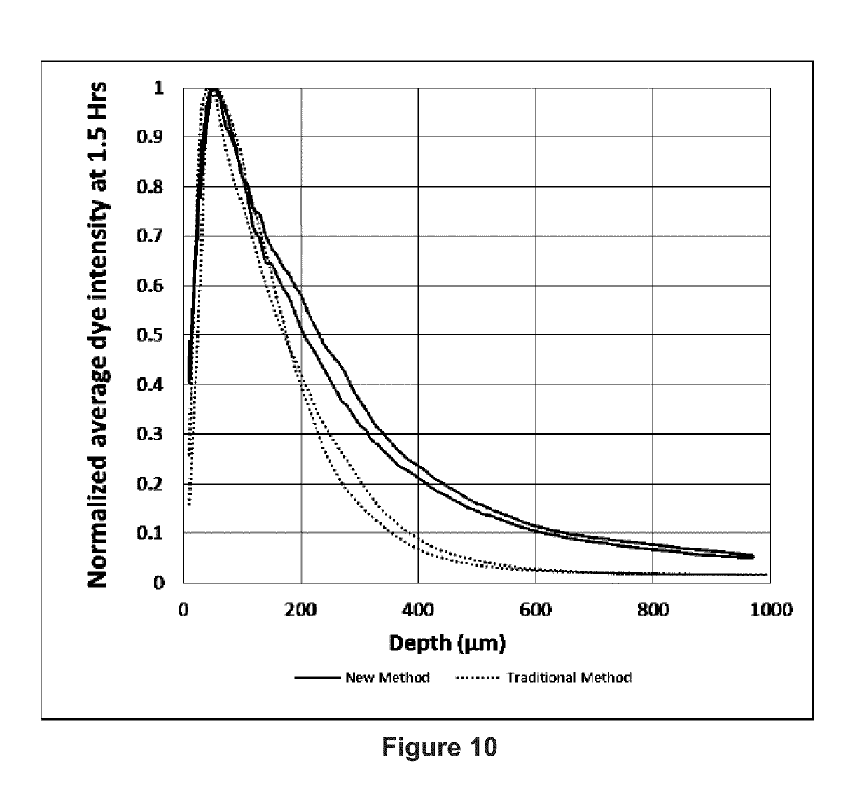

At time 1.5 h, tissue processing using the methods of the present invention exhibits significantly better dye penetration than a fast processing method using standard reagent combinations of increasing ethanol concentrations, followed by hexane, followed by BABB clearing. The normalized average dye staining as a function of depth at 1.5 h is depicted in FIG. 10. These results demonstrate that the use of a permeant during dehydration and dyeing can further increase the rate of sample processing when a dye is incorporated in the dehydration step.

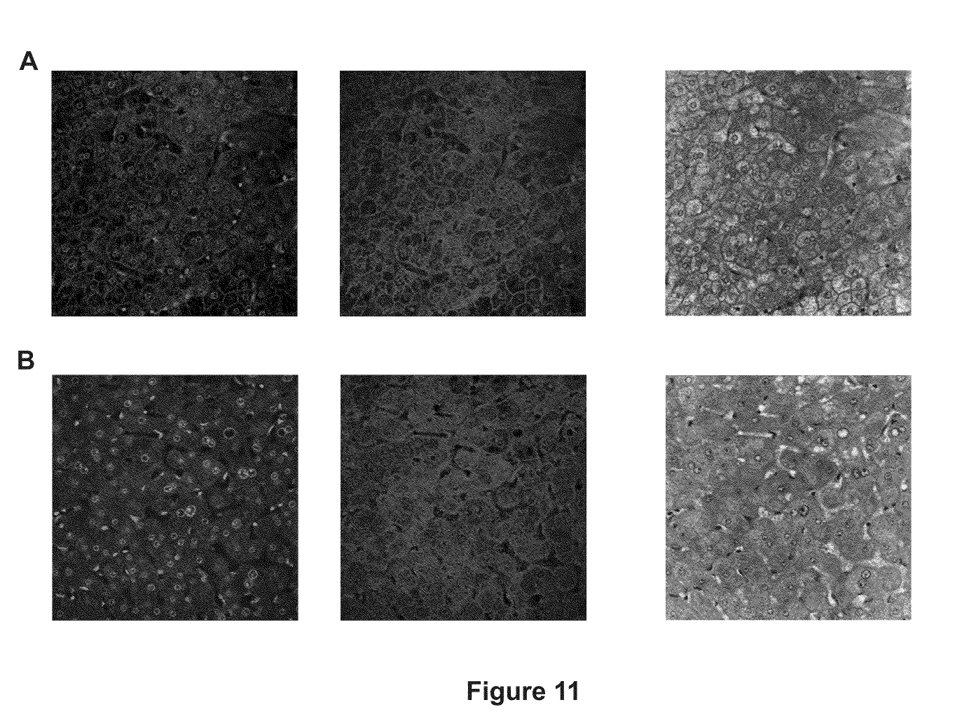

FIG. 11 depicts images of tissues processed using traditional ethanol/hexane/BABB processing methods (FIG. 11A) and using the methods of the present invention (FIG. 11B). The methods of the present invention result in better separation of nuclear and protein fluorescence signals with inexpensive dye combinations (much brighter nuclei in FIG. 11B) and exhibit improved detail at 500 μm deep with significantly less cell shrinkage (smaller average cell size in FIG. 11A) in these images from the same normal human liver. The artifacts created by the traditional process make it unacceptable for clinical interpretation. Also, the images in this figure were obtained after a total processing time of only 1.5 hours, faster than any routine method for clinical tissue slice preparation, including microwave-based methods which are known to adversely affect morphology, and faster than other comparable clearing methods currently in use. In addition, the tissues processed using the methods of the present invention were whole and un-embedded in paraffin, making them available in their entirety for additional testing, which cannot be accomplished using other currently available processing methods.

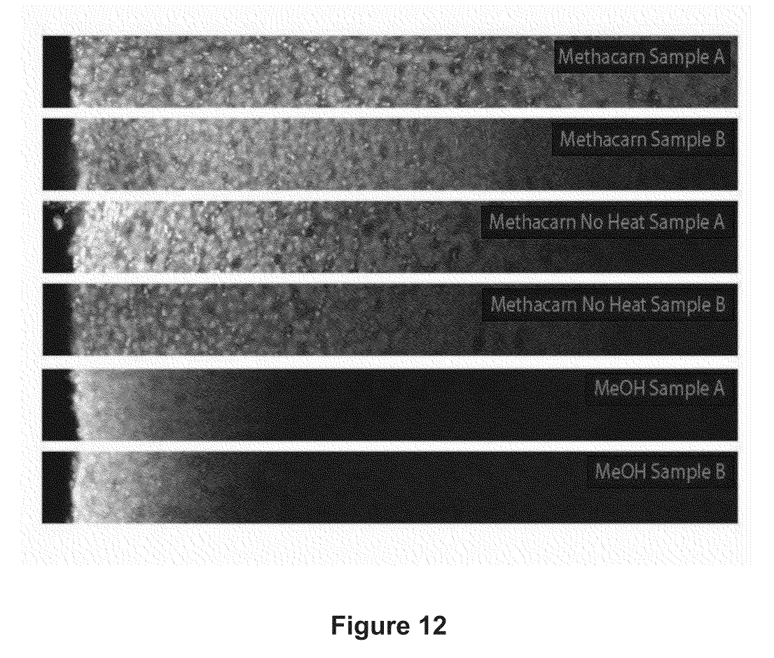

FIG. 12 is a series of images depicting images of tissue samples processed using methacarn or methanol alone, and treated with heat or without heat.

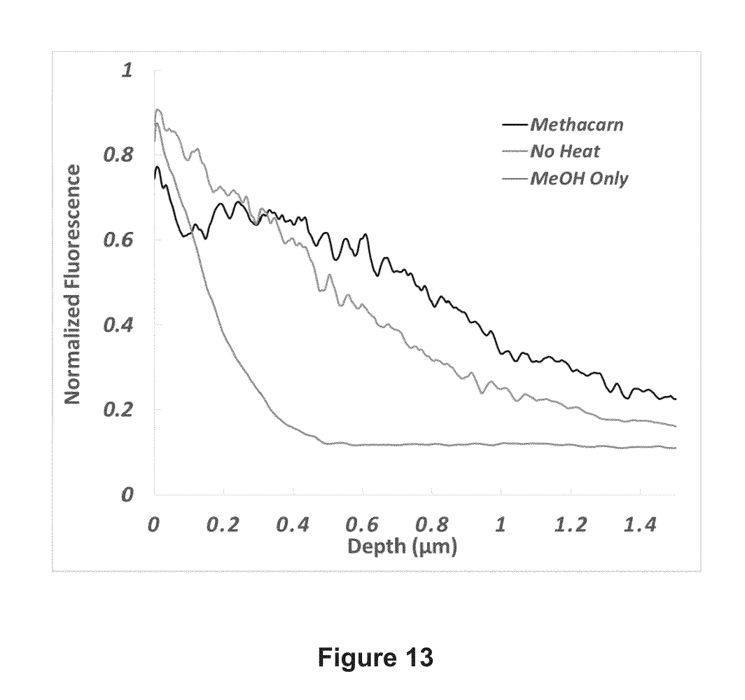

FIG. 13 is a graph derived from the images of FIG. 12 depicting normalized fluorescence staining versus depth for samples processed with methacarn, methanol only, and no heat. This graph demonstrates the benefits of using methacarn, which includes glacial acetic acid as a permeant, and heat for better dye penetration.

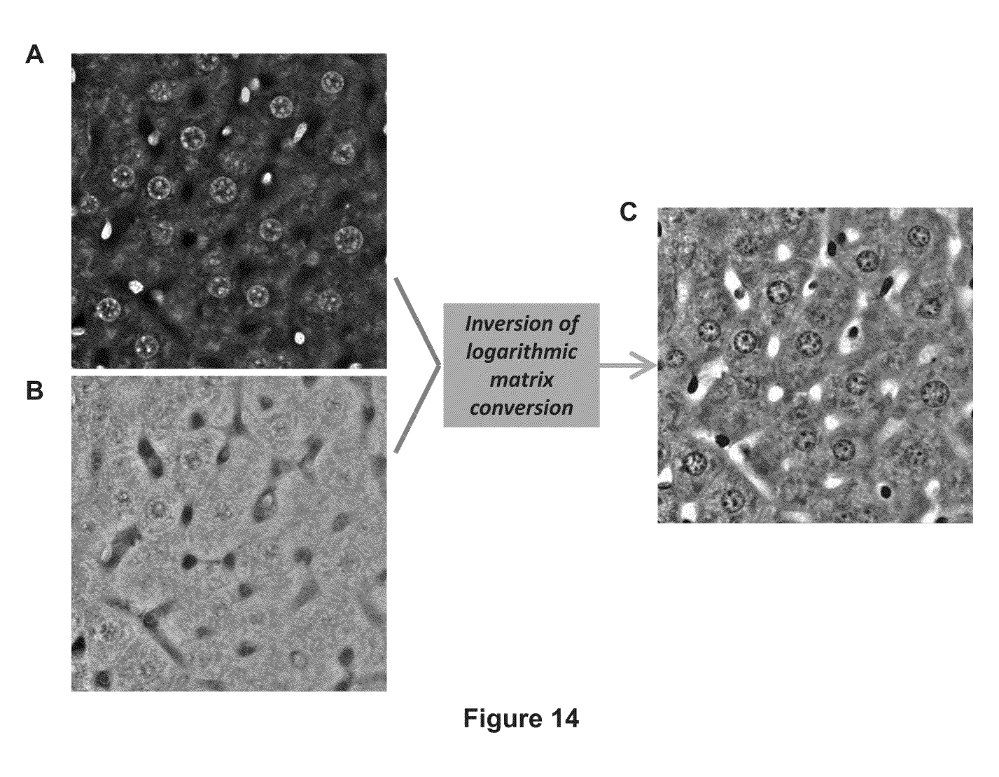

FIG. 14 depicts images of tissues processed using pseudo-H&E. FIG. 14A is an image of tissue processed with nuclear stain. FIG. 14B is an image of tissue processed with protein fluorescence. FIG. 14C is an image of tissue imaged with an exponential matrix conversion of fluorescence intensity values using images depicted in FIGS. 14A and 14B. It reproduces near perfectly a traditionally fixed, sectioned, and hematoxylin and eosin stained pathology slide image.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A method of processing a tissue sample, the method comprising the steps of:
obtaining a tissue sample; and
contacting the tissue sample with a fixative solution comprising at least one fixative and at least one fluorescent dye;
wherein the step of contacting the tissue sample with a fixative solution is performed over a period of less than 1 hour.

2. The method of claim 1, further comprising the step of contacting the tissue sample with a clearing solution.

3. (canceled)

4. The method of claim 1, wherein the at least one fluorescent dye is selected from the group consisting of eosin, DAPI, SYTOX green, acridine orange, rhodamine B, propidium iodide, and a Hoechst dye.

5. The method of claim 1, wherein the at least one fixative is methacarn.

6. The method of claim 1, wherein the fixative solution further comprises a permeation enhancer.

7. The method of claim 1, wherein the step of contacting the tissue sample with a fixative solution is performed at about 45° C.

8. The method of claim 1, wherein the fixative solution further comprises a red blood cell lysing agent.

9. (canceled)

10. The method of claim 1, wherein the step of contacting the tissue sample with a fixative solution is performed over a period of less than 15 minutes.

11. The method of claim 2, wherein the clearing solution comprises benzyl alcohol and benzyl benzoate.

12. The method of claim 11, wherein the ratio of benzyl alcohol to benzyl benzoate is about 1:2.

13. The method of claim 2, wherein the step of contacting the tissue sample with a clearing solution is performed over a period of time of less than 10 minutes.

14. The method of claim 2, wherein a partially fixed and a partially cleared tissue is placed in fixative after imaging.

15. (canceled)

16. The method of claim 1, wherein the tissue sample is fixed prior to obtaining the tissue sample.

17. A method of imaging a tissue sample, the method comprising the steps of:
obtaining a tissue sample;
contacting the tissue sample with a fixative solution comprising at least one fluorescent dye;
contacting the tissue sample with a clearing solution; and
producing a tissue sample image by measuring intensity values of the fluorescence of the tissue sample, and converting the intensity values to effective optical densities, such that the optical densities recreate the coloration of a stain in a produced image of the tissue sample.

18. The method of claim 17, wherein the tissue sample image is produced using an optical sectioning microscope.

19. The method of claim 18, wherein the optical sectioning microscope is selected from the group consisting of: a multiphoton microscope (MPM), a confocal microscope, a structured illumination microscope, a super-resolution microscope, a selective plane illumination microscope (SPIM), a side-plane illumination microscope, a spinning disk confocal microscope, and a deconvolution microscope.

20. The method of claim 17, wherein the step of producing a tissue sample image further comprises second harmonic generation (SHG).

21. The method of claim 17, wherein the sample image is a three dimensional (3-D) sample image.

22. The method of claim 17, wherein the sample image is obtained at a sample depth greater than 50 μm.

23. The method of claim 17, wherein the intensity values are converted to effective optical densities using an exponential pseudo-coloration process.

24-48. (canceled)
